(19) United States
(12) Patent Application Publication
(10) Pub. No.: US 2009/0230295 A1
(43) Pub. Date: Sep. 17, 2009

(54) MEASUREMENT OF HYDRAULIC CONDUCTIVITY USING A RADIOACTIVE OR ACTIVATABLE TRACER

(75) Inventors: Christopher Leslie Waring, New South Wales (AU); Peter Lewis Airey, New South Wales (AU); Yury A. Stepanyants, New South Wales (AU)

Correspondence Address: KNOBBE MARTENS OLSON & BEAR LLP, 2040 MAIN STREET, FOURTEENTH FLOOR, IRVINE, CA, 92614, US

(73) Assignee: Australian Nuclear Science & Technology Organisation, Lucas Heights, New South Wales (AU)

(21) Appl. No.: 12/295,256

(22) PCT Filed: Mar. 29, 2007
(86) PCT No.: PCT/AU2007/000405

§ 371 Date: Feb. 16, 2009

(30) Foreign Application Priority Data
Mar. 29, 2006 (AU) 2006901602

(51) Int. Cl. G01V 5/04; E21B 47/10

(52) U.S. Cl. 250/260; 73/152.18

(57) ABSTRACT

A method of determining the distance, from a reference point, of a tracer emitting radiation comprising a first component emitted at a first known energy level and a second component emitted at a second known energy level, the intensity of a penetrating portion of the first component that penetrates a substance between the tracer and the reference point and the intensity of a penetrating portion of the second component of the radiation that penetrates the substance being a function of the rate of gamma radiation emission of the tracer as well as of the distance of the tracer from the reference point, the method comprising: a) measuring the intensity of the first penetrating portion and the intensity of the second penetrating portion; b) determining the ratio of the intensity of the first penetrating portion to the intensity of the second penetrating portion; and c) determining the distance of the tracer from the reference point.

### TECHNICAL FIELD

The present invention relates to the measurement of conductivity of liquids in underground formations. More particularly, the invention relates to a method of determining the distance from a borehole of a volume of liquid in an underground environment of the borehole, to a method of determining hydraulic conductivity of a liquid in an underground environment of a borehole, to a system for determining hydraulic conductivity of a liquid in an underground environment of a borehole, and to an apparatus for determining the distance from a borehole of a volume of liquid in an underground environment of the borehole.

The invention further relates to a bore-logging tool adaptable for use in determining the distance, from a borehole, of a volume of liquid in an underground environment of the borehole. The invention also relates to a tool and a kit adaptable for use in determining hydraulic conductivity.

### BACKGROUND OF THE INVENTION

One method that is currently used for the measurement of hydraulic conductivity in underground formations involves the pumping of water, under pressure, into the formations surrounding a borehole, and the subsequent measurement of the volume and pressure of water flowing from the borehole. This method is referred to as the “pump testing” method.

The measurement of hydraulic conductivity according to the pump testing method is subject to inherent inaccuracies. These inaccuracies may be ascribed to:
a) inaccuracies in the formulae used for calculation of the hydraulic conductivity;
b) an imperfect correlation between actual and calculated flow rates as a function of decreasing pressure differential between the inside and the outside of the borehole; and
c) inaccuracies originating from approximations and averaging of measured values.

A further disadvantage of this method is that, in existing boreholes lined with casings, there are either no holes through the casing in the zone of interest or, where slots or holes have been provided, they are located only in predetermined regions. Because of the influence of the positions of such holes on the flow of liquids in the borehole and its environment, these and other factors complicate the use of the pump testing method and contribute to its inaccuracy.

Screen intervals in the bore casing range from about 3 m to about 6 m. Even greater screen widths than 6 m are sometimes used. Typically, this means one low spatial resolution value per well, which may not accurately represent the true variability of hydraulic conductivity at that site. The inherent hydraulic conductivity variability could be 5 orders of magnitude at any one site and with a narrow screen interval the full range of hydraulic conductivity cannot be determined with an acceptable degree of accuracy.

Conventional use of tracers, which may be radioactive, for detecting groundwater flow, requires the use of multiple boreholes. A tracer is typically injected into one borehole and its concentration in nearby boreholes is then monitored to obtain information about groundwater flow between the boreholes. However, the costs associated with the application of this method could be high if the boreholes have to be drilled specially for this purpose. The method also requires many analyses to detect the tracer in adjacent boreholes, which is laborious, time consuming and costly.

U.S. Pat. No. 4,032,781 describes a method for locating and measuring the entry of undesirable water cut into a cased well borehole having multiple sets of longitudinally spaced perforations for the production of fluids from formations communicating with the well bore. This method involves the repetitive irradiation, in bursts, of the borehole environs with a source of high energy neutrons and detecting, subsequent to each burst, gamma rays emitted by atoms in the environs as a result of the decay of ¹⁶N to ¹⁶O. A linear flow rate of water is then calculated using information derived from the gamma rays detected as a result of the aforementioned nuclear reaction, and using the known internal diameter of the borehole, a volumetric flow rate is calculated, assuming the flow occurs inside the borehole. This method is clearly unsuitable for the determination of liquid flows in a three dimensional environment, particularly where it is important to determine the direction of flow as well as the hydraulic conductivity.

Furthermore, the aforementioned patent is directed to a method of determining relatively high water speeds of about 25 to 50 mm per second. The method is unsuitable for the measurement of flow velocities below about 10 mm per second.

In addition, the aforementioned patent teaches the calculation of the distance of the tracer on the basis of the ratio that the measured intensity of radiation forms to the known intensity decay of the primary radiation. Attenuation of radiation, which occurs as a result of Compton scattering, is considered in respect of only one energy level, and is therefore inaccurate and unreliable.

There accordingly exists a need for a method of measuring hydraulic conductivity in underground formations that addresses the fundamental problems associated with the pump testing and simple tracer techniques.

### SUMMARY OF THE INVENTION

According to a first aspect of the invention, there is provided a method of determining the distance, from a reference point, of a radioactive or an activatable tracer emitting radiation comprising a first component emitted at a first known energy level and a second component emitted at a second known energy level, the intensity of a penetrating portion of the first component that penetrates a substance between the tracer and the reference point and the intensity of a penetrating portion of the second component of the radiation that penetrates the substance, being a function of the rate of gamma radiation emission of the radioactive or activatable tracer as well as of the distance of the tracer from the reference point, the method comprising:
measuring the intensity of the first penetrating portion and the intensity of the second penetrating portion;
determining the ratio of the intensity of the first penetrating portion to the intensity of the second penetrating portion; and
determining the distance of the tracer from the reference point using the equation

$$Rt ( l ) ≡ \frac{{I}_{tot}^{1} ( l )}{{I}_{tot}^{2} ( l )} = \frac{{μ}_{2}}{{μ}_{1}} \frac{1 - {e}^{- {μ}_{1} l}}{1 - {e}^{- {μ}_{2} l}} . \qquad ( 1 )$$

wherein
Rt(l) is the ratio of the integral intensities of the tracer gamma radiation emission at two different energies;
l is the distance of the volume of liquid containing the radiotracer from the reference point;
Iₜₒₜ¹(l) represents the total (integral) intensity of the tracer at the first energy as a function of the distance from the reference point;
Iₜₒₜ²(l) represents the total (integral) intensity of the tracer at the second energy as a function of the distance from the reference point;
μ₁ is the attenuation coefficient of the first component of the radiation corresponding to the first the energy; and
μ₂ is the attenuation coefficient of the second component of the radiation corresponding to the second the energy; and further wherein if an activatable tracer is used then the method further comprises the step of activating the activatable tracer before the step of measuring the intensity of the first penetrating portion and the intensity of the second penetrating portion.

The radiation may be selected from the group consisting of gamma radiation and X-rays. Gamma radiation is preferred.

The energy levels may vary from about 0.1 MeV to about 10 MeV, about 0.5 MeV to about 10 MeV, about 1.0 MeV to about 10 MeV, about 1.0 MeV to about 7 MeV, and about 1.0 MeV to about 5 MeV.

The difference between the first and second energy levels is preferably greater than 0.1 MeV, 0.2 MeV, 0.3 MeV, 0.4 MeV or 0.5Mev to maximise the differential energy absorption coefficient.

The detector may be from the group of gamma radiation scintillation detectors. The gamma radiation detector may be a bismuth germinate (BGO) detector, a lanthanum bromide (LaBr₃Ce) detector, or a lanthanum chloride (LaCl₃Ce) detector, cadmium telluride, cadmium zinc telluride, sodium iodide, or a high purity germanium HPGe detector.

According to a second aspect of the invention, there is provided a method of determining the distance from a borehole of a radioactive or activatable tracer in an underground environment of the borehole, wherein the radioactive or activatable tracer emits gamma radiation comprising a first component emitted at a first known energy level and a second component emitted at a second known energy level, the intensity of a penetrating portion of the first component that penetrates the environment and the intensity of a penetrating portion of the second component of the gamma radiation that penetrates the environment being a function of the rate of gamma radiation emission of the radioactive or activatable tracer as well as of the distance of the tracer from the borehole, the method including the steps of:
measuring the intensity of the penetrating portion of the first energy component of the radioactive or activatable tracer;
measuring the intensity of the penetrating portion of the second energy component of the tracer;
determining the ratio of the intensity of the first energy component to the intensity of the second energy component;
determining the distance of the tracer from the borehole using equation (1) and wherein if an activatable tracer is used then the method further comprises the step of activating the activatable tracer before the steps of measuring the intensity of the penetrating portion of the first and second energy component of the activatable tracer.

According to a third aspect of the invention, there is provided a method of determining the volume of a tracer plume of a fluid moving in an environment. The method includes the steps of
introducing into the environment a radioactive or activatable tracer emitting radiation comprising at least two radioactive components emitted at a first known energy level and at a second known energy level;
after the elapse of a period of time, measuring the intensity of the first penetrating portion and the intensity of the second penetrating portion;
determining the ratio of the measured intensity of the first penetrating portion to the intensity of the second penetrating portion;
determining a distance that the tracer has moved in the environment, away from the reference point, during the period of time, using equation (1);
determining the volume of the tracer plume using an appropriate equation depending on the shape of the plume; and wherein if an activatable tracer is used then the method further comprises the step of activating the activatable tracer before the steps of measuring the intensity of the first penetrating portion and the second penetrating portion.

For instance, assuming that the plume has a cylindrical shape of a height H. the volume of the plume can be determined from the following equation

V=πr²H+επ(R²−r²)H (2)

wherein V is the volume of the plume in borehole and porous rock;
R is the radius of the plume formed when the solute occupied the given volume during the period of time. The equation similar to one-dimensional equation (1) but generalised for the axi-symmetrical case can be used for determining the radial distance R;
r is the radius of the borehole;
H is the height of the cylindrical plume.
ε is the porosity of the rock volume within the radius R (0≦ε≦1)

According to a fourth aspect of the invention, there is provided a method of determining a hydraulic conductivity of an underground environment in the direct vicinity of a borehole, including the steps of:
introducing into the environment, from the borehole, and at a known depth, a radioactive or activatable tracer emitting radiation comprising the first and second components emitted at two known energy levels penetrating the environment;
after the elapse of a period of time, measuring the intensity of the first and second penetrating components of the tracer, at least at the known depth, using a detector located in the borehole;
determining the ratio of the measured intensity of the first penetrating component to the measured intensity of the second penetrating component;
determining a distance that the tracer has moved in the environment, away from the borehole, during the time period, using the ratio as described by an equation analogous to Equation (1) but applicable to the two-dimensional axi-symmetric case; determining the seepage velocity of the liquid moving in the environment and containing the tracer and further wherein if an activatable tracer is used then the method further comprises the step of activating the activatable tracer before the step of measuring the intensity of the first and the second penetrating components.

The seepage velocity may be determined by dividing the determined distance R over elapsed time t, that is Vₛₚ=R/t.

The method of the further aspect may further comprise determining the hydraulic conductivity in the vicinity of the plume using an estimation based on Darcy's law where Darcy's law reads:

Vₛₚ=−K∇Ψ (3a)

or in one-dimensional case

$${V}_{sp} = - K \frac{d Ψ}{d r} , \qquad ( 3 b )$$

where
Vₛₚ is Darcy's seepage velocity,
K is the hydraulic conductivity (measured in m/s) of the environment of the borehole,
r is the distance, and
Ψ=ψ+p/ρg, is the total pressure head in meters with ψ being liquid head, p—atmospheric pressure, ρ—liquid density, g—acceleration due to gravity.

From equation (3), one obtains in the scalar case

$$K = - \frac{{V}_{sp}}{d Ψ / d r} \approx - \frac{{V}_{sp}}{Δ Ψ / Δ r} = \frac{{V}_{sp} Δ r}{Δ Ψ} , \qquad ( 4 )$$

where symbol Δ stands for the absolute finite difference for the corresponding value.

According to a fifth aspect of the invention, there is provided a method of determining hydraulic conductivity of an underground environment away from the borehole, including the steps of:
introducing into the environment, from the borehole, and at a known depth, a radioactive or activatable tracer emitting radiation comprising the first and second components emitted at two known energy levels penetrating the environment;
after the elapse of a period of time, measuring the intensity of the first and second penetrating components of the tracer, at least at the known depth, using a detector located in the borehole;
determining the ratio of the measured intensity of the first penetrating component to the measured intensity of the second penetrating component;
determining a distance R1 that the tracer has moved in the environment, away from the borehole, during the time period, using the ratio as described by equation analogous to equation (1) but applicable to the two-dimensional axi-symmetric case;
repeating the first four steps and determining a distance R2 that the tracer has moved further in the environment, away from the borehole, during the new time period;
determining the seepage velocity of the liquid moving in the environment and containing the radiotracer, under a measured hydraulic gradient, wherein the hydraulic gradient is determined by the difference between hydraulic pressure in the borehole and the hydraulic pressure in the adjacent rock; and wherein if an activatable tracer is used then the method further comprises the step of activating the activatable tracer before the step of measuring the intensity of the first and second penetrating components.

The seepage velocity may be determined by dividing the determined distance difference R₂−R₁ over elapsed time difference t₂−t₁, that is Vₛₚ=(R₂−R₁)/(t₂−t₁); R₁ may equal 0, the initial state of the borehole prior to introduction of the tracer.

The method of the fifth aspect of the invention may further comprise the step of determining the hydraulic conductivity in the environment located away from the borehole.

Darcy's formula is used again at this stage by combining the definition for the seepage velocity and equation (3), one obtains the formula for determining the hydraulic conductivity:

$$K = {V}_{sp} \frac{Δ r}{Δ Ψ} \approx \frac{Δ r}{Δ t} \times \frac{Δ r}{Δ Ψ} = \frac{{( Δ r )}^{2}}{Δ Ψ Δ t} , \qquad ( 5 )$$

wherein
Δt is the time elapsed between two introductions of the radiotracer into the environment;
Δr is the distance difference obtained for the time period Δt.

The hydraulic conductivity of the underground environment may be determined in respect of a plane incorporating the axis of the borehole and extending in a first direction, by applying the method in accordance with the invention and by measuring the intensities of the penetrating portions of the first component and the second component of radiation, at the known depths and at given directions. As a result thereof, the spatial dependency of the hydraulic conductivity can be determined.

As an alternative, the hydraulic conductivity may be determined for a cylindrical space incorporating the borehole and being co-axial with the borehole, by measuring the intensities of penetrating portions of the first component and the second component of radiation by determining IS the volume occupied by the liquid from the borehole, before the elapse of the time period and thereafter. En determining the aforementioned distances, the equation similar to equation (1) but valid for the cylindrical case may be used. As before, the hydraulic conductivity may be determined by applying equation (5) to the distances so obtained.

The system in accordance with the invention may incorporate means for providing, in the liquid in the underground environment of the borehole, the radioactive or activatable tracer.

It is envisaged that the system may include an apparatus comprising the means for measuring the intensities of the penetrating portions of the first component and the second component of the radiation. The apparatus may, in addition, comprise the means for determining the ratio of the intensity of the first penetrating portion to the intensity of the second penetrating portion. Furthermore, the apparatus may also comprise the means for determining the distance of the volume of the liquid from the borehole, before and after the elapse of the time period. In a preferred embodiment of the invention, the apparatus also comprises means for determining the hydraulic conductivity of the underground environment using the distances before and after the elapse of the time period.

According to a sixth aspect of the invention, there is provided an apparatus for determining the distance from a borehole of a volume of liquid in an underground environment of the borehole, the volume of liquid comprising a radioactive or activatable tracer emitting gamma radiation, the gamma radiation comprising a first component radiated at a first known energy level and a second component radiated at a second known energy level, the intensity of a penetrating portion of each of the first and second components of the radiation being a function of the source intensity of the radioactive or an activated tracer as well as of the distance of the tracer from the borehole; the apparatus comprising:
means for measuring the intensities of the penetrating portions of the first component and the second component, at least at the known depth and at least in respect of a first direction;
means for determining the ratio that the intensity of the first penetrating portion forms to the intensity of the second penetrating portion;
means for determining the distance of the volume of liquid from the borehole and further wherein if an activatable tracer is used then the apparatus further comprises means for activating the activatable tracer to form the activated tracer.

Throughout the specification and claims the ratio that the intensity of the first penetrating portion forms to the intensity of the second penetrating portion refers to the ratio:

intensity of the first penetrating portion/intensity of the second penetrating portion.

According to one embodiment of the invention, there is provided an apparatus for determining the distance, from a reference point, of a radioactive or an activatable tracer emitting radiation comprising a first component emitted at a first known energy level and a second component emitted at a second known energy level, the intensity of a penetrating portion of the first component that penetrates a substance between the tracer and the reference point and the intensity of a penetrating portion of the second component of the radiation that penetrates the substance, being a function of the rate of gamma radiation emission of the radioactive or activatable tracer as well as of the distance of the tracer from the reference point, the apparatus comprising:
means for measuring the intensity of the first penetrating portion and the intensity of the second penetrating portion;
means for determining the ratio of the intensity of the first penetrating portion to the intensity of the second penetrating portion; and
means for determining the distance of the tracer from the reference point using the equation

$$Rt ( l ) ≡ \frac{{I}_{tot}^{1} ( l )}{{I}_{tot}^{2} ( l )} = \frac{{μ}_{2}}{{μ}_{1}} \frac{1 - {e}^{- {μ}_{1} l}}{1 - {e}^{- {μ}_{2} l}} . \qquad ( 1 )$$

wherein
Rt(l) is the ratio of the integral intensities of the tracer gamma radiation emission at two different energies;
l is the distance of the volume of liquid containing the radiotracer from the reference point;
Iₜₒₜ¹(l) represents the total (integral) intensity of the tracer at the first energy as a function of the distance from the reference point;
Iₜₒₜ²(l) represents the total (integral) intensity of the tracer at the second energy as a function of the distance from the reference point;
μ₁ is the attenuation coefficient of the first component of the radiation corresponding to the first the energy; and
μ₂ is the attenuation coefficient of the second component of the radiation corresponding to the second the energy; and further wherein if an activatable tracer is used then the apparatus may comprise means for activating the activatable tracer before measuring the intensity of the first penetrating portion and the intensity of the second penetrating portion.

According to a seventh aspect of the invention, there is provided a spectral gamma ray logging tool adaptable for use in a borehole after injecting into an environment of the borehole a volume of liquid comprising a radioactive or activatable tracer emitting gamma radiation, the gamma radiation comprising a first component radiated at a first known energy level and a second component radiated at a second known energy level, wherein an intensity of a penetrating portion of each of the first and second components of the radiation is a function of the source intensity of the radioactive tracer or an activated tracer as well as of the distance of the tracer from the borehole; the tool comprising:
means for measuring the intensities of the penetrating portions of the first component and the second component, at least at the known depth and at least in respect of a first direction;
means for determining the ratio that the intensity of the first penetrating portion forms to the intensity of the second penetrating portion;
means for determining the distance of the volume of liquid from the borehole and further wherein if an activatable tracer is used then the spectral gamma ray logging tool further comprises means for activating the activatable tracer to form the activated tracer.

The spectral gamma ray logging tool may further comprise: means for measuring and monitoring the concentration of the tracer solution; means for monitoring and adjusting the flow rate of the tracer solution to the borehole; means for measuring and monitoring the volume of the tracer solution; and means for measuring the hydraulic pressure in the borehole. The means for measuring and monitoring the concentration of the tracer solution, means for monitoring and adjusting the flow rate of the tracer solution to the borehole, means for measuring and monitoring the volume of the tracer solution, and means for measuring the hydraulic pressure in the borehole may be located in a separate apparatus which may be used in combination with the spectral gamma ray logging tool.

The means for determining the distance of the volume of liquid from the borehole may be adapted to solve equation (1) for l.

According to a eighth aspect of the invention, there is provided an apparatus for determining the distance from a borehole of a radioactive or activatable tracer in an underground environment of the borehole, wherein the radioactive or activatable tracer emits gamma radiation comprising a first component emitted at a first known energy level and a second component emitted at a second known energy level, the intensity of a penetrating portion of the first component that penetrates the environment and the intensity of a penetrating portion of the second component of the gamma radiation that penetrates the environment being a function of the rate of gamma radiation emission of the radioactive or activatable tracer as well as of the distance of the tracer from the borehole. The apparatus may comprise:
means for measuring the intensity of the penetrating portion of the first energy component of the radioactive or activatable tracer;
means for measuring the intensity of the penetrating portion of the second energy component of the tracer;
means for determining the ratio of the intensity of the first energy component to the intensity of the second energy component;
means for determining the distance of the tracer from the borehole using equation (1) and wherein if an activatable tracer is used then the apparatus further comprises means for activating the activatable tracer before measuring the intensity of the penetrating portion of the first and second energy component of the activatable tracer.

According to a ninth aspect of the invention, there is provided an apparatus for determining the volume of a tracer plume of a fluid moving in an environment. The apparatus may comprise:
means for introducing into the environment a radioactive or activatable tracer emitting radiation comprising at least two radioactive components emitted at a first known energy level and at a second known energy level;
means for after the elapse of a period of time, measuring the intensity of the first penetrating portion and the intensity of the second penetrating portion;
means for determining the ratio of the measured intensity of the first penetrating portion to the intensity of the second penetrating portion;
means for determining a distance that the tracer has moved in the environment, away from the reference point, during the period of time, using equation (1);
means for determining the volume of the tracer plume using an appropriate equation depending on the shape of the plume; and wherein if an activatable tracer is used then the apparatus may further comprise means for activating the activatable tracer before measuring the intensity of the first penetrating portion and the second penetrating portion.

According to a tenth aspect of the invention, there is provided an apparatus of determining a hydraulic conductivity of an underground environment in the direct vicinity of a borehole. The apparatus may comprise:
means for introducing into the environment, from the borehole, and at a known depth, a radioactive or activatable tracer emitting radiation comprising the first and second components emitted at two known energy levels penetrating the environment;
means for after the elapse of a period of time, measuring the intensity of the first and second penetrating components of the tracer, at least at the known depth, using a detector located in the borehole;
means for determining the ratio of the measured intensity of the first penetrating component to the measured intensity of the second penetrating component;
means for determining a distance that the tracer has moved in the environment, away from the borehole, during the time period, using the ratio as described by an equation analogous to Equation (1) but applicable to the two-dimensional axi-symmetric case; determining the seepage velocity of the liquid moving in the environment and containing the tracer and further wherein if an activatable tracer is used then the apparatus may further comprise means for activating the activatable tracer before measuring the intensity of the first and the second penetrating components.

According to a eleventh aspect of the invention, there is provided an apparatus for determining hydraulic conductivity of an underground environment away from the borehole. The apparatus may comprise:
means for introducing into the environment, from the borehole, and at a known depth, a radioactive or activatable tracer emitting radiation comprising the first and second components emitted at two known energy levels penetrating the environment;
means for after the elapse of a period of time, measuring the intensity of the first and second penetrating components of the tracer, at least at the known depth, using a detector located in the borehole;
means for determining the ratio of the measured intensity of the first penetrating component to the measured intensity of the second penetrating component;
means for determining a distance R1 that the tracer has moved in the environment, away from the borehole, during the time period, using the ratio as described by equation analogous to equation (1) but applicable to the two-dimensional axi-symmetric case;
means for determining a distance R2 that the tracer has moved further in the environment, away from the borehole, during the new time period;
means for determining the seepage velocity of the liquid moving in the environment and containing the radiotracer, under a measured hydraulic gradient, wherein the hydraulic gradient is determined by the difference between hydraulic pressure in the borehole and the hydraulic pressure in the adjacent rock; and wherein if an activatable tracer is used then the apparatus may further comprise means for activating the activatable tracer before measuring the intensity of the first and second penetrating components.

According to an twelfth aspect of the invention, there is provided a kit for use in a borehole after injecting into an environment of the borehole a volume of liquid comprising a radioactive or activatable tracer emitting gamma radiation, the gamma radiation comprising a first component radiated at a first known energy level and a second component radiated at a second known energy level, wherein an intensity of a penetrating portion of each of the first and second components of the radiation is a function of the source intensity of the radioactive tracer or an activated tracer as well as of the distance of the tracer from the borehole; the kit comprising:
means for measuring the intensities of the penetrating portions of the first component and the second component, at least at the known depth and at least in respect of a first direction;
means for determining the ratio that the intensity of the first penetrating portion forms to the intensity of the second penetrating portion;
means for determining the distance of the volume of liquid from the borehole and further wherein if an activatable tracer is used then the kit further comprises means for activating the activatable tracer to form the activated tracer.

As used in this specification, the following expressions shall be taken to have the following meanings:

“Gamma radiation” shall mean electromagnetic radiation having a wave length smaller than or equal to 2×10⁻¹⁰ m and a quantum energy (E) of more than 10 KeV;

“Providing in the environment a radioactive tracer” shall include the injection of the radioactive tracer into the environment and the irradiation of a non-radioactive substance into the environment causing it to become radioactive;

“Injection into the environment . . . ” shall include the mere release into the environment;

“Hydraulic conductivity” shall mean the constant of proportionality between hydraulic head gradient and liquid flux expressed in meters per second;

“Hydraulic resistance” shall mean the ratio of the thickness of a material to its hydraulic conductivity and is expressed in seconds;

“Tracer” shall mean a radioactive element dissolved in a volume of a liquid or as a volume of liquid containing a neutron activatable element that when stimulated emits gamma radiation, to serve as an indicator of the position of such volume of such liquid;

“Borehole” shall be construed so as to include “well”;

“Chemically conservative salt” refers to a salt which does not react with the surroundings in the flow path (i.e., adsorption change phase reaction).

Direction may conveniently be expressed as an angle compared to a reference direction. Such measurements may be made at the same time or before and after the elapse of a third known time period which may be the same as the first and/or second known time periods or different therefrom. The measurements may be used to calculate liquid mobility in a three dimensional imaginary cylinder having a centre line which is the same as the centre line of the borehole.

The method according to any of the aforementioned aspects of the invention may include the step of thoroughly mixing the radioactive or activatable tracer with water throughout a column of water or other liquid in the borehole. It may further include the step of applying a known pressure head to the borehole to induce the injection of the radioactive or activatable tracer into the environment of the borehole.

The radioactive tracer may be in the form of a suitable chemical substance comprising a radioactive element. The radioactive element may be prepared off site or alternatively, it may be prepared in situ by a suitable source of radioactivity such as a source radiating neutrons having sufficiently high energy. The radiation may be of sufficient energy to cause elements in the borehole environment to become radioactive.

Depending on the nature of the materials and formations in the borehole environment, neutrons could have a penetrating range up to about 10 cm, about 20 cm, about 30 cm, about 40 cm, about 50 cm, about 60 cm, about 70 cm, about 80 cm, about 90 cm or up to about 1 m.

The tracer may be a radioactive tracer or an activatable tracer. The tracer may be a dissociative salt or an ionic bonded salt. The tracer may be a chemically conservative salt. The tracer may be a metal salt with a high neutron cross-section such as for example an Mn or a Gd salt.

The radioactive tracer may be a simple chemically conservative salt such as NaCl, KCl, MnCl₂, Na₂SO₄, K₂SO₄, NaBr or KBr, or combinations thereof with one or more of the elements combined in the salt being a radioactive isotope.

The activatable tracer may be a simple chemically conservative salt such as NaCl, KCl, MnCl₂, Na₂SO₄, K₂SO₄, NaBr or KBr, or combinations thereof where one or more elements are able to be activated with incident neutrons to emit gamma radiation.

The chemical salt may be selected from the group of NaCl, KCl, or KBr, or combinations thereof. The salt may be labelled with ⁸²Br.

Sodium chloride is commonly available and is relatively cheap. In addition, it may already be present in underground water. In the event that it is present in sufficient concentration, it may be made radioactive by irradiating it with neutrons. The tracer could alternatively be water only. The tracer distance measured by diminution of the activatable salt as it is displaced by the water injection. The distance of the water tracer from the borehole could be measured by differential gamma radiation attenuation, which may be by diminution of the salt intensity.

The radioactive or activatable tracer may be a mixture of two or more of the compounds selected from the group consisting of NaCl, KCl, MnCl₂, Na₂SO₄, K₂SO₄, NaBr and KBr.

The tracer conveniently emits gamma radiation at various energy levels. The choice of tracer may be determined by factors such as the rock and ground water forming part of the borehole environment. The tracer should be selected so as to avoid chemical reaction of the tracer with the rock in the borehole environment or with the borehole casing.

The radioactive or activatable tracer may alternatively be selected so as to take into account the sensitivity of the detector to detect different energy emissions. A further consideration is the half-life of the tracer which should be selected for the time appropriate for moving a measurable distance into the environment of the borehole, at a manageable pressure. For ecological reasons, it is advantageous to use a short-lived tracer.

Sodium or potassium bromide, in which the bromide is ⁸²Br, may be used as a tracer. ⁸²Br has the advantage that it emits gamma radiation and has a half-life of only about 35 hours.

However, for slow moving liquids, the half-life of ⁸²Br may be too short. It is preferable to use a long lived tracer only after it has been established that the hydraulic conductivity of the liquid in the borehole environment is low, and where it has been established that greater accuracy is essential than could be obtained by using ⁸²Br.

⁸²Br has four measurable energies. In order to obtain reliable data on hydraulic conductivity, it is considered to be necessary to measure at least two different energies so as to obtain two different attenuating curves.

The method according to the invention thus relies on the differential attenuation, with distance from the borehole, of different energy levels of gamma emissions from the same elemental tracer. The differential attenuation of the energy curves of the two energies is dependent on the distance of the tracer from the release point as well as on the differential absorption of energy by material between the tracer and a detector located in the borehole.

The measurement of the differential attenuation of two different energy levels enables the resolution of an ambiguity which may be ascribed to a decreasing radiation count as a result of two or more unrelated phenomena, such as distance from the detector, concentration of the tracer and flow of water away from the detector. For example, a low gamma count by the detector could be due to a small amount of tracer having been absorbed by the borehole environment after the tracer was injected into it. Alternatively or additionally it could be due to the absorption of a proportion of the radiation by the borehole environment. Another factor which could have contributed to the low count, is movement of the tracer away from the detector over some distance. The ratio of emitted energies from the tracer for different energy levels, however, enables the determination of the distance of the tracer from the detector, as shown in equation (1).

When the rate of flow as may be derived from a knowledge of time and distance that the tracer has moved, as well as the pressure differential between the borehole and its environment are input into Darcy's equation for fluid flow in porous media, then the hydraulic conductivity of the borehole environment may be calculated.

Accurate measurement of hydraulic conductivity is necessary for the construction of reliable groundwater flow models. These groundwater flow models are the basic management tool for assessing sustainable groundwater use.

The rate of migration of a groundwater contaminant plume may also be calculated. Plume migration may be calculated using a flow model such as MODFLOW from the USGS, which uses hydraulic conductivity as one important descriptive variable in the model.

In an advantageous embodiment of the invention, the head in the borehole is maintained constant to ensure that the tracer is injected into the borehole environment at a constant rate.

Hydraulic conductivity may be determined, using the method according to the invention, for each of a number of different layers of rock or material in the vicinity of the borehole. Measurements for such layers may be done over a number of hours or days. The measurement may be performed over a time period of 0.01 hours to 5 days. In other arrangements, the measurement may be performed over a time period of 0.5 to 5 hours, corresponding with a rate of logging the borehole of 1 to 2 metres per minute and consequent borehole depth ranges of 30m to 600m. In still further arrangements, the measurement may be performed over a time period corresponding with a different rates of logging the borehole or different borehole depths for example, the time period may be of 0.01 to 24 hours, 0.01 to 23, 0.01 to 22, 0.01 to 21, 0.01 to 20, 0.01 to 19, 0.01 to 18, 0.01 to 17, 0.01 to 16, 0.01 to 15, 0.01 to 14, 0.01 to 13, 0.01 to 12, 0.01 to 11, 0.01 to 10, 0.01 to 9, 0.01 to 8, 0.01 to 7, 0.01 to 6, 0.01 to 5, 0.01 to 4, 0.01 to 3, 0.01 to 2, 0.01 to 1, 0.01 to 0.5, 0.5 to 24, 0.5 to 23, 0.5 to 22, 0.5 to 21, 0.5 to 20, 0.5 to 19, 0.5 to 18, 0.5 to 17, 0.5 to 16, 0.5 to 15, 0.5 to 14, 0.5 to 13, 0.5 to 12, 0.5 to 11, 0.5 to 10, 0.5 to 9, 0.5 to 8, 0.5 to 7, 0.5 to 6, 0.5 to 5, 0.5 to 4, 0.5 to 3, 0.5 to 2, 0.5 to 1, 1 to 24, 1 to 23, 1 to 22, 1 to 21, 1 to 20, 1 to 19, 1 to 18, 1 to 17, 1 to 16, 1 to 15, 1 to 14, 1 to 13, 1 to 12, 1 to 1, 1 to 10, 1 to 9, 1 to 8, 1 to 7, 1 to 6, 1 to 5, 1 to 4, 1 to 3, 1 to 2, 2 to 12, 2 to 10, 2 to 9, 3 to 12, 3 to 11, 3 to 10, 3 to 9, 3 to 8, 4 to 12, 4 to 11, 4 to 10, 4 to 9, 4 to 8, 4 to 7, 4 to 6 hours, or 1 to 5, 1 to 4, 1 to 3, 1 to 2, 2 to 5, 2 to 4, 2 to 3, 3 to 5, 3 to 4, or 4 to 5 days.

To obtain information about the flow direction, the data logging probe may be shielded in respect of radiation originating from all directions except one, so that the radiation received from that direction is the only radiation that is considered. The direction from which radiation is measured may be varied or progressively increased for sequential measurements, so as to determine variations in tracer movement attributable to direction, and hence a directional flow velocity.

For rock minerals, the relationship between the ratios and the distance is about constant for a given permeability and viscosity. Viscosity adjustment may be made for liquids having higher viscosity such as brines and oils.

The method according to the invention may be used in water management. Alternatively it may be used in the assessment of ground water salinity variations. Another application of the invention is in the in situ monitoring of possible leaching of waste radioactive materials, where such waste materials have been stored in underground storage and it has become necessary or desirable to determine whether any leakage of radioactive substances is occurring.

One advantage of the invention is that hydraulic conductivity of a liquid in an underground environment may be determined more accurately than with the pump test method. It has been found, using the method in accordance with the invention, that an incremental resolution of as little as about 10 cm is obtainable for an uncased borehole, without packers to isolate each injection zone. Whereas the standard pump flow test resolution is of the order of meters, if not more. A further advantage of the method according to the invention is that the need for multiple boreholes to determine hydraulic conductivity is obviated.

The invention also extends to a spectral gamma radiation bore-logging tool whenever used in applying a method in accordance with the invention. The spectral gamma ray bore-logging tool may also conveniently comprise a suitable source of radioactivity. It may thus be adapted to emit radiation of a type that is capable of causing a non-radioactive substance to become radioactive. Thus, it may be capable of emitting neutrons capable of penetrating into the nuclei of atoms in the environment of the borehole. Depending on the nature of the materials and formations in the borehole environment, neutrons could have a penetrating range up to about 1 m.

### BRIEF DESCRIPTION OF THE DRAWINGS

The invention is described below, by way of example, with reference to the accompanying drawings, wherein:

FIG. 1 is a representation of a one-dimensional model describing the movement of a radioactive tracer through a medium;

FIG. 2 shows theoretical distribution curves for a smooth injection case, a fast injection case and a diffusive intrusion case respectively;

FIG. 3 shows theoretical distribution functions for the three curves of FIG. 2;

FIG. 4 is a diagrammatic representation of two different distribution functions;

FIG. 5 represents the data of FIG. 2 but shown on a semilog scale;

FIG. 6 is a representation of a two dimensional model for determining of radiation from a radioactive tracer in a horizontal plane perpendicular to the borehole and extending in a given direction;

FIG. 7 is a representation of a three dimensional model for determining of radiation from a radioactive tracer at a depth z in a space around the vertical borehole and extending in a given direction;

FIG. 8 is a diagrammatic representation of the apparatus used to carry out the examples;

FIG. 9 is a diagrammatic top plan view of the apparatus of FIG. 8;

FIG. 10 is a graph showing count rate versus distance in air from a source referred to as No 1 for a ¹³⁷Cs tracer and from a source referred to as No 4, for a ⁶⁰Co tracer, asterisks representing measured data whilst the graphs are straight lines according to the best fit to the measured data;

FIG. 11 is a graph showing count rate versus distance in water from a source referred to as No 3 and 3* for a ⁶⁰Co tracer, with the diamond shaped points representing measured data and the graph being a straight line which is the best fit for the data shown;

FIG. 12 is a graph showing count rates versus distance in air and in a water from a source referred to as No 5 for a ¹³⁷Cs tracer (Asterisks and diamonds are measured data; straight lines are the best fit data interpolations for the last 6 points on each line);

FIG. 13 is a graph showing count rates versus distance in dry sand from the source referred to as No 6 for a ¹³⁷Cs tracer (Diamonds and squares are measured data; straight lines are the best-fit data interpolations);

FIG. 14 is a graph showing count rates versus distance in water saturated sand from the source referred to as No 6 for a ¹³⁷Cs tracer (Diamonds and squares are measured data; straight lines are the best-fit data interpolations);

FIG. 15 is a graph showing count rates versus distance in water saturated sand from the source referred to as No 7 for a ⁶⁰Co tracer (Circles and diamonds are measured data; straight lines are the best-fit data interpolations);

FIG. 16 is a graph showing the distribution of salt water injected into a porous material contained in a tank, with the depth of the resulting salt water plume represented on the vertical axis and the radius of the plume (which is related to the volume occupied by the salt water) represented on the horizontal axis;

FIG. 17 is a graph showing hydraulic conductivity of the salt water injected into the tank referred to in relation to FIG. 16, calculated for various positions of the salt water front in the tank;

FIG. 18 is a graph showing seepage velocity of the salt water injected into the tank referred to in relation to FIGS. 16 and 17, calculated for various periods of time after injection;

FIG. 19 is a schematic representation of a borehole and apparatus used to obtain the hydraulic conductivity using an activatable tracer in accordance with an embodiment of the invention;

FIG. 20A shows the log of H/Cl (counts in single gamma spectral region corresponding to H and Cl) for a number of NaCl activatable tracer injections into the borehole as shown in FIG. 19;

FIG. 20B shows the corresponding log of depth (m) against total counts from natural gamma radiation (U, Th, K) in borehole MW6;

FIG. 21 shows a graph of the depth (m) against the Hydraulic Conductivity (×10-8 m/s) for the activatable tracer example as shown in FIG. 19;

FIG. 22 shows a graph of the depth (m) against the distance between point source and detector (cm) for the activatable tracer example as shown in FIG. 19;

FIG. 23 shows a graph of the depth (m) to the ratio of the gamma peaks for A, B and C for the activatable tracer example as shown in FIG. 19;

FIG. 24 shows a graph of the depth (m) against the distance to source (cm) for the activatable tracer example as shown in FIG. 19;

FIG. 25 is shows an example count spectrum obtained from a single PGNA spectrum in iron ore;

FIG. 26 is stratigraphic correlation of a borehole with respect to the tracer penetration/hydraulic conductivity;

FIG. 26A is a graph of comparison PGNA spectra using a BGO gamma radiation detector with spectra obtained using a lanthanum bromide LaBr3Ce gamma radiation detector;

FIG. 27 is a schematic of a prompt gamma neutron activation (PGNA) logging system;

FIG. 27A shows an example arrangement of a PGNA borehole logging device;

FIG. 27B is a schematic of an example removable housing for a neutron source for the device of FIG. 27A;

FIG. 27C is a schematic of an example PGNA borehole logging device showing the detector shielding;

FIG. 27D is a further schematic of the PGNA borehole logging device of FIG. 27C;

FIG. 28 shows a screen shot of a example control software user interface;

FIG. 29 shows a schematic of the main routines of the control software of FIG. 28;

FIG. 30 is a schematic of a loop flow diagram for the monitor panel of the interface of FIG. 28

FIG. 31 is a schematic of a loop flow diagram for the control panel of the interface of FIG. 28;

FIG. 32 shows a screen shot of the setup panel of the control software user interface of FIG. 28;

FIG. 33 is a schematic of a loop flow diagram for the setup panel of FIG. 32;

FIG. 34 shows a screen shot of the falling head control panel of the control software user interface of FIG. 28;

FIG. 35 is a schematic of a loop flow diagram for the panel of FIG. 32;

FIG. 36 shows a screen shot of the mix/unmix control panel of the control software user interface of FIG. 28;

FIG. 37 is a schematic of a loop flow diagram for the panel of FIG. 36;

FIG. 38 shows a screen shot of the inject/push control panel of the control software user interface of FIG. 28;

FIG. 39 is a schematic of a loop flow diagram for the panel of FIG. 38;

FIG. 40 shows a screen shot of the purge control panel of the control software user interface of FIG. 28;

FIG. 41 is a schematic of a loop flow diagram for the panel of FIG. 40; and

FIG. 42 is shows a schematic diagram of a down-hole, isolated zone-of-interest groundwater sampler.

### DETAILED DESCRIPTION

### Attenuation of Radiation in One Dimension

In FIG. 1, the distribution, in a one dimensional model, of a radioactive tracer is shown along an axis x.

If it is assumed that the radioactive tracer is distributed non-uniformly, then its density of distribution may be characterised by the function F(x)=I₀(x)e^{-tln2/τ}, where τ is the half-life time of the tracer.

The intensity of gamma radiation received by a detector placed into a borehole, from a volume dx at distance x from the borehole is F(x)dx=I₀(x)e^{-tln2/τ}e^{-μx}dx, where μ(E) is the attenuation factor which depends on the excitation energy. Hence, the total intensity of the received gamma radiation at a borehole from the whole interval [0, l] is:

$${I}_{tot} ( l ) = {e}^{- t ln 2 / τ} {\int }_{0}^{l} {I}_{0} ( x ) {e}^{- μ x} d x . \qquad ( 6 )$$

This value depends both on the spatial interval I across which the radioactive tracer is distributed and on the distribution function I₀(x).

The following three cases have been considered as models for different regimes of tracer distribution:

### Case 1: The “Uniform Distribution” Case

In this case, the tracer is assumed to be uniformly distributed over the interval 0<x<l with the concentration I₀=M/l remaining constant, where M is the total “mass” of radioactive material and l is the distance. The following equation may then be derived:

$${I}_{tot} ( l ) = \frac{M}{μ l} ( 1 - {e}^{- μ l} ) {e}^{- t ln 2 / τ} . \qquad ( 7 )$$

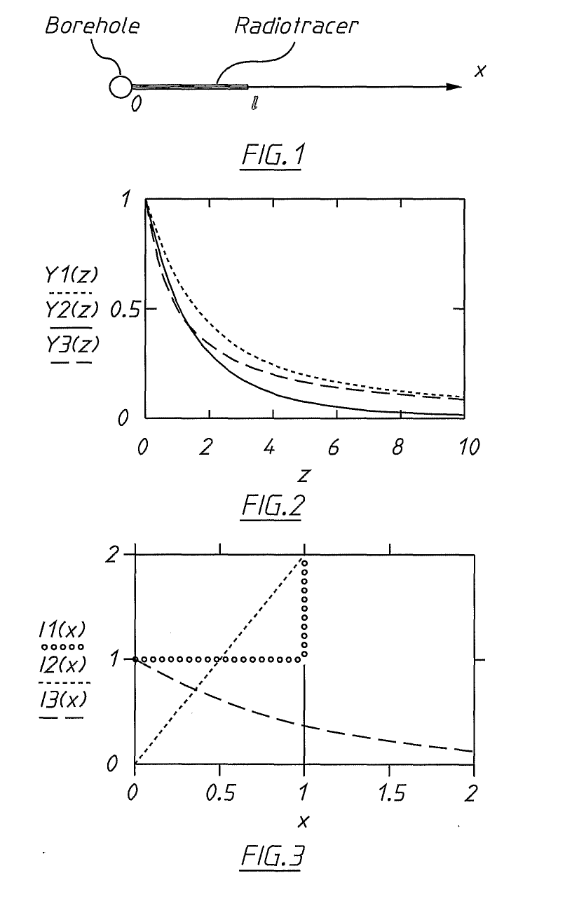

This relationship is illustrated in FIG. 2.

In normalised variables, the aforementioned relationship may be expressed as follows:

$${Y}_{1} ( z ) = \frac{1}{z} ( 1 - {e}^{- z} ) , \\ where \\ {Y}_{1} ≡ \frac{{I}_{tot}}{M} {e}^{t ln 2 / τ} , and z ≡ μ l . \qquad ( 8 )$$

### Case 2: The “Fast Injection” Case

For this case, it is assumed that the tracer is distributed linearly with the density of distribution I₀(x)=2Mx/l² at 0<x<l.

The intensity of radiation received at the borehole can be expressed as follows:

$${I}_{tot} ( l ) = \frac{2 M}{{μ}^{2} {l}^{2}} [ 1 - ( 1 + μ l ) {e}^{- μ l} ] {e}^{- t ln 2 / τ} . \qquad ( 9 )$$

This relationship is illustrated in FIG. 2.

Using the same normalised variables as before, it can be expressed as follows:

$${Y}_{2} ( z ) = \frac{2}{{z}^{2}} [ 1 - ( 1 + z ) {e}^{- z} ] . \qquad ( 10 )$$

### Case 3: The “Diffusive Intrusion” Case

For this case, it is assumed that the tracer is distributed exponentially over the distance l as follows: I₀(x)=(M/l)e^{-x/l}.

The intensity of radiation received at the borehole can be expressed as follows:

$${I}_{tot} ( l ) = \frac{M}{1 + μ l} {e}^{- t ln 2 / τ} . \qquad ( 11 )$$

Using the same normalised variables as before, it can be represented as follows (see FIG. 2):

$${Y}_{3} ( z ) = \frac{1}{1 + z} \qquad ( 12 )$$

The three different distribution functions considered above are depicted in FIG. 3.

However, as can be seen in FIGS. 2 and 3, the dependence of gamma radiation counts on distance is qualitatively the same for all three distribution functions, with the result that the nature of the assumption as to what the distribution profile is, is relatively unimportant. In all three cases, the signal received by a detector placed in the borehole, decreases with increasing distance over which the tracer is distributed.

The decay rate of the received signal decreases faster (slower) if a maximum of distribution function is shifted in the space to the remote (nearby) part of a domain of distribution.

Two more models considered below further illustrate the dependence of Iₜₒₜ(l) on the localisation of radioactive materials on the axis x.

### Case 4: The “Remote Localisation” Case

Radioactive material is assumed to be uniformly distributed over the interval l−a<x<l with the density I₀=M/a being constant.

The intensity of radiation received at the borehole for this case can be expressed as:

$${I}_{tot} ( l ) = \frac{M}{μ a} {e}^{- μ l} ( {e}^{μ a} - 1 ) {e}^{- t ln 2 / τ} . \qquad ( 13 )$$

Using the normalised variables as before, this equation can be converted to the following equation:

$${Y}_{4} ( z ) = \frac{{e}^{α} - 1}{α} {e}^{- z} , α ≡ μ a . \qquad ( 14 )$$

This relationship is illustrated in FIG. 5 for a particular value of parameter μ=0.1.

### Case 5: The “Nearby Localisation” Case

The tracer is assumed to be uniformly distributed over the interval 0<x<a with the density I₀=M/a=constant. The intensity relationship may be expressed as follows:

$${I}_{tot} ( l ) = \frac{M}{μ a} ( 1 - {e}^{- μ a} ) {e}^{- t ln 2 / τ} . \qquad ( 15 )$$

Using the normalised variables as above, it becomes:

$${Y}_{5} ( z ) = \frac{1 - {e}^{- α}}{α} = const , α ≡ μ a . \qquad ( 16 )$$

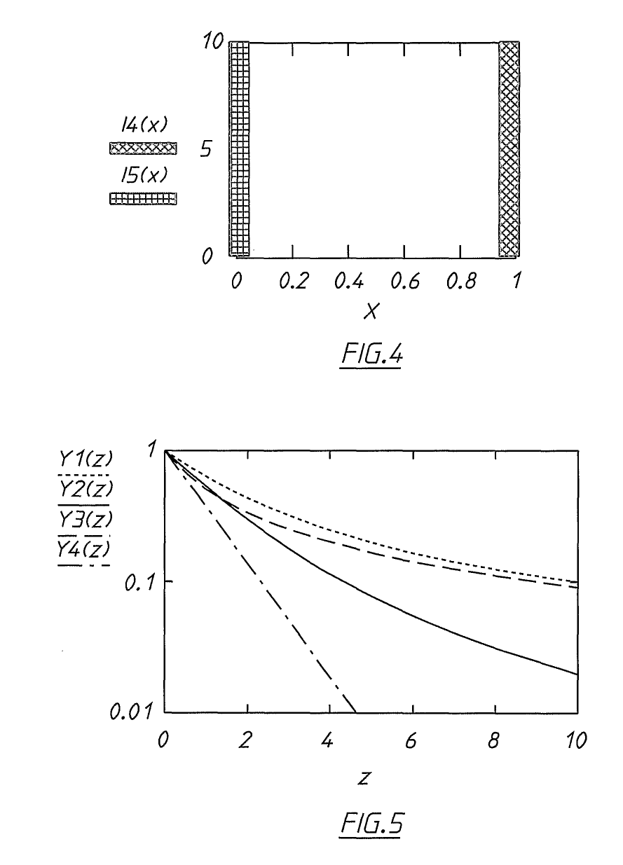

FIG. 4 shows a qualitative representation of the distribution functions of tracers for equations (14) and (16).

In FIG. 5, the three curves of FIG. 2 are presented on a semilog scale. The fourth curve represents the relationship of equation (14).

### Two Dimensional and Three Dimensional Cases

Assume now that the tracer distribution in a space depends both on a distance r and on an azimuth θ and is described by the function F(r)=I₀(r,θ)e^{-tln2/τ}.

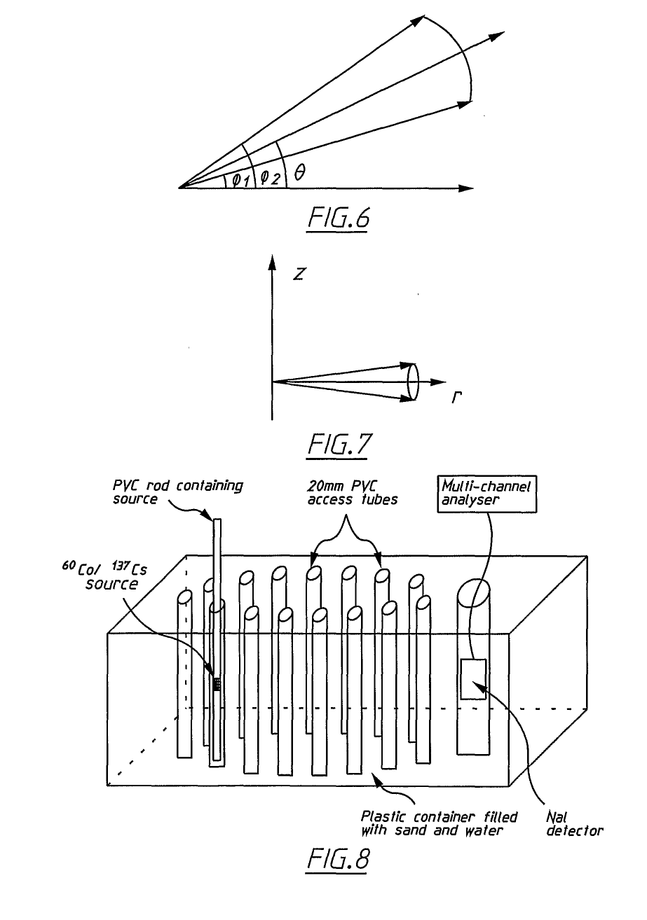

The intensity of the received gamma-radiation at a borehole from a volume ds of a unit height in a vertical direction z is Fds=I₀(r, φ)e^{-tln2/τ},e^{-μr}rdrdφ. Hence, the total intensity of the received gamma-radiation at a borehole from the sectorial domain bounded by rays φ₁ and φ₂ (FIG. 6) is:

$${I}_{tot} ( l , θ ) = {e}^{- t ln 2 / τ} {\int }_{{ϕ}_{1}}^{{ϕ}_{2}} d ϕ {\int }_{0}^{l} {I}_{0} ( r , ϕ ) {e}^{- μ r} r d r , \qquad ( 17 )$$

where θ is the angle between some fixed direction and average direction of observation.

In the particular case when the intensity of gamma-radiation does not depend on the azimuth, equation (17) reduces to the following:

$${I}_{tot} ( l , θ ) = ( {ϕ}_{2} - {ϕ}_{1} ) {e}^{- t ln 2 / τ} {\int }_{0}^{l} {I}_{0} ( r ) {e}^{- μ r} r d r , θ = ( {ϕ}_{1} + {ϕ}_{2} ) / 2. \qquad ( 18 )$$

A similar generalisation can be developed in a 3D case. A distribution function of gamma-radiation in this case depends on a distance r, on an azimuth φ and on another spherical angle ψ: F(r)=I₀(r,φ, ψ)e^{-tln2/τr}.

An intensity of the received gamma-radiation at a “borehole” from a volume dv is Fdv=I₀(r,φ,ψ)e^{-tln2/τ}e^{-μr}r² cos ψdrdφdψ. Hence, the total intensity of the received gamma-radiation at a borehole from the conic domain bounded by rays φ₁, φ₂ and ψ₁, ψ₂ (FIG. 7) is:

$${I}_{tot} ( l , θ , z ) = {e}^{- t ln 2 / τ} {\int }_{{ϕ}_{1}}^{{ϕ}_{2}} d ϕ {\int }_{{ψ}_{1}}^{{ψ}_{2}} cos ψ d ψ {\int }_{0}^{l} {I}_{0} ( r , ϕ , ψ ) {e}^{- μ r} {r}^{2} d r , \qquad ( 19 )$$

where z is a vertical coordinate of a receiver.

In the particular case when the intensity of gamma-radiation does not depend on the azimuth φ or on the spherical angle ψ, formula (16) reduces to the following one:

$${I}_{tot} ( l , θ , z ) = ( {ϕ}_{2} - {ϕ}_{1} ) ( \begin{matrix}sin {ψ}_{2} - \\ sin {ψ}_{1}\end{matrix} ) {e}^{- t ln 2 / τ} {\int }_{0}^{l} {I}_{0} ( r ) {e}^{- μ r} {r}^{2} d r , \\ θ = ( {ϕ}_{1} + {ϕ}_{2} ) / 2. \qquad ( 20 )$$

Step-by-Step Calculation of Hydraulic Conductivity from the Data of Field Measurements

It is assumed that the data of field measurements of gamma-radiation is available as a function of polar angle, θ, and depth, z: i.e., the intensity of gamma-radiation (count rate) at a given excitation energy, E, can be presented in the form Iₜₒₜ=f(θ,z). In practice, this function of two variables can be presented as:

TABLE 1
Intensity of gamma-radiation as a function of polar angle at different depth.

| | Angle, θ | | | | | | | | | | | |
|---|---|---|---|---|---|---|---|---|---|---|---|---|
| Depth, z, m | 0 | 30 | 60 | 90 | 120 | 150 | 180 | 210 | 240 | 270 | 300 | 330 |
| 1 | 535 | 520 | 503 | 499 | 548 | 496 | 509 | 488 | 501 | 490 | 517 | 485 |
| 2 | 504 | 497 | 546 | 494 | 507 | 486 | 499 | 488 | 515 | 483 | 531 | 517 |
| 3 | 548 | 496 | 509 | 488 | 501 | 490 | 517 | 485 | 535 | 520 | 503 | 499 |

The intensity of gamma-radiation measured by the detector from the certain direction at fixed depth, zᵢ, depends on the effective length, l, over which the tracer is distributed. In the simplest case of a uniform distribution of a radioactive material in one-dimensional space, the total intensity registered by the detector at given excitation energy, E, is determined by means of formula (20) above.

Considering the responses of the detector at two excitation energies (which are available from the multi-channel detector), E₁ and E₂, and taking a ratio of signals at these energies, one obtains equation (1).

This formula allows to calculate the effective distance l.

The effective distance, in a first approximation, is proportional to the seepage velocity, I=Vt, where t is a time counting from the beginning of a solute pumping to the borehole. The seepage velocity, V, is determined by Darcy's law

V=−K(∇p+ρg∇z), (21)

where K(θ,z) is the hydraulic conductivity of a considered layer, ∇p is a pressure gradient, ρ is solute density, g is the acceleration due to gravity, and ∇z is a unit vector directed downward.

Hence, one can conclude that the effective distance is proportional to the hydraulic conductivity: the larger the conductivity the longer the path covered by the tracer for a given time.

By means of the dependence R(O), equation (1), one can calculate the effective distance 1, which is proportional to the hydraulic conductivity K. This method in the presented form allows to estimate only a relative hydraulic conductivity as a function of spatial coordinates, say polar angle, θ, and depth, z: K=F(θ, z). To obtain an absolute value of the hydraulic conductivity, one needs to have only one independent measurement of the hydraulic conductivity at a fixed point by means of different method.

### EXAMPLES

The following examples 1 to 5 were done to obtain laboratory measurements of gamma-radiation from two different radioactive sources (⁶⁰Co, ¹³⁷Cs). The laboratory measurements were conducted to measure gamma-radiation from a given “point” source located at varying distances from the detector.

All measurements in example 1 to 5 were conducted using a similar experimental set up.

The measurements were conducted in air, water and river sand (both dry and water saturated). The decay rate of gamma-radiation was measured as a function of distance for all types of media mentioned above. The experimental data can be interpreted using the theoretical formula developed for one dimension using the appropriate model of distribution function.

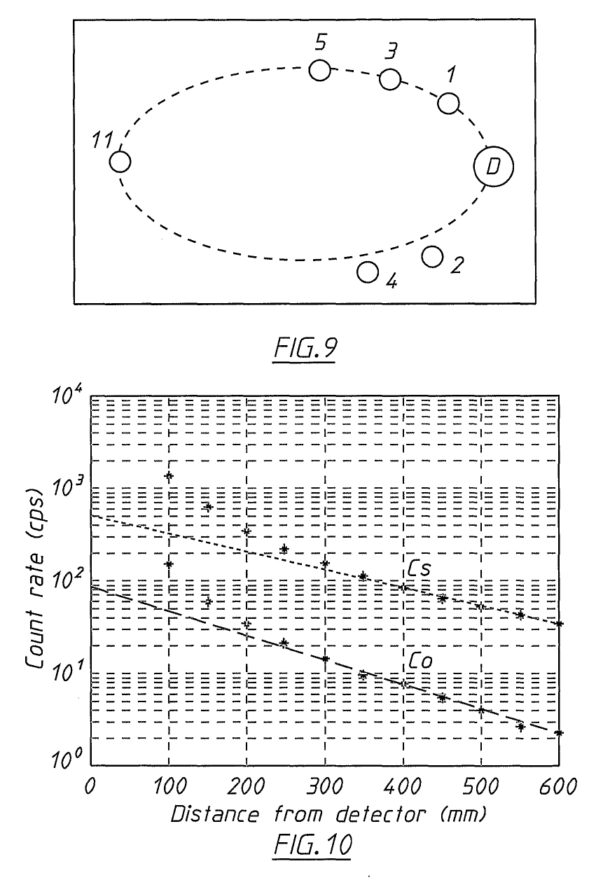

A laboratory tank (length×width×height: 900 mm×600 m×500 m) was covered by polymer glass with holes made at uniformly increasing distances from the position of a detector. This is shown in FIGS. 8, 9 and 10.

Experiments were carried out with the laboratory tank filled with either air, water or river sand. Two radioactive sources were used: ¹³⁷Cs and ⁶⁰Co, each having a different intensity. Sources were located at distances d=100, 150, 200 . . . 600 mm from the detector. Gamma radiation was counted within a fixed energy range of interest. The counting was performed to satisfy two conditions:

a) t_{count}>>1 s; and (22)

b) N_{count}>>1. (23)

To confirm the validity of these conditions, a preliminary experiment was conducted. Counting of gamma radiation from each of the two radioactive sources was performed in air with the sources located at distance of 300 mm from the detector. From this data the count rate was calculated. These results are presented in Table 2.

The measurement times used were 10 s, 100 s and 1000 s. Each run was repeated twice under the same conditions. One can see that if measurement time was relatively short, 10 s, the results obtained (the last column of Table 2) differ from each other by up to 14%. This difference decreased as the measurement times were increased to 100 s, and it was insignificant if the measurement time was increased to 1000 s. Hence, one can conclude that for practical purposes measurement time within the range of 100-1000 s will produce good quality results. Note that some compromise between the experimental accuracy and the duration of measurement must be achieved, since very extended count times are impractical. Using this recommendation, and taking into account conditions a) and b) above, we carried out a series of measurements to calibrate our apparatus and to check the relationship between theoretical and experimental data on gamma radiation decay with distance in different media (air, water, river sand).

TABLE 2
Data of measurement of gamma radiation in the air from two sources
(#2, ¹³⁷Cs and #5, ⁶⁰Co) located at fixed
distance (300 mm) from the detector.

| | | ROI | | Peak | | | Distance | |
|---|---|---|---|---|---|---|---|---|
| Run | Isotope | KeV | Time s | KeV | Peak HT | Area | mm | Rate |
| 1 | Cs-137 #2 | 598-730 | 10 | 670 | 29 | 951 | 300 | 95 |
| 4 | | | 10 | 665 | 26 | 829 | 300 | 83 |
| 2 | | | 100 | 675 | 217 | 8177 | 300 | 82 |
| 5 | | | 100 | 662 | 221 | 8464 | 300 | 85 |
| 3 | | | 1000 | 666 | 2074 | 87039 | 300 | 87 |
| 6 | | | 1000 | 663 | 2056 | 86546 | 300 | 87 |
| 1 | Co-60 #5 | 1229-1381 | 10 | 1315 | 50 | 2100 | 300 | 210 |
| 2 | | | 10 | 1304 | 47 | 1959 | 300 | 196 |
| 4 | | | 100 | 1305 | 443 | 23039 | 300 | 230 |
| 5 | | | 100 | 1310 | 402 | 22428 | 300 | 224 |
| 3 | | | 1000 | 1295 | 3888 | 222249 | 300 | 222 |
| 6 | | | 1000 | 1298 | 3902 | 219130 | 300 | 219 |

### Example 1

### Attenuation of Gamma-Radiation in air using a Cs-137 Source

A first series of experiments was conducted using atmospheric air. Table 3 contains data from this first experiment. One can see that both above conditions were satisfied. On the 5 basis of results obtained a count rate (the last column of the Table 2) has been calculated and plotted versus distance in semi-logarithmic scale (FIG. 11).

According to theoretical prediction, the count rate must exponentially depend on distance from the source in the homogeneous medium. It is proportional to the intensity of gamma radiation, which is described by the well-known formula:

I(l)=e^{-tln2/τ}I₀e^{-μl}, (24)

where t is a current time from the fixed but arbitrary instant; τ is the half-life time of the radioactive material; μ(E) is the attenuation factor which depends on the excitation energy.

TABLE 3
Data of Measurement of Gamma Radiation in the Air from
Source #1 (Cs-137), located at different distances from the detector.

| | | Peak | | | Distance | |
|---|---|---|---|---|---|---|
| Run | Time s | KeV | Peak HT | Area | mm | Rate |
| 1 | 217 | 661 | 6126 | 303010 | 100 | 1396.36 |
| 2 | 270 | 668 | 3527 | 169505 | 150 | 627.8 |
| 3 | 232 | 661 | 1746 | 81999 | 200 | 353.44 |
| 4 | 241 | 662 | 1215 | 53125 | 250 | 220.44 |
| 5 | 332 | 658 | 1129 | 51443 | 300 | 154.95 |
| 6 | 421 | 659 | 1071 | 47210 | 350 | 112.14 |
| 7 | 524 | 656 | 1052 | 42061 | 400 | 80.27 |
| 8 | 984 | 660 | 1572 | 62862 | 450 | 63.88 |
| 9 | 847 | 663 | 1137 | 45251 | 500 | 53.43 |
| 10 | 898 | 663 | 1006 | 38541 | 550 | 42.92 |
| 11 | 1067 | 657 | 1021 | 37069 | 600 | 34.74 |

In reality, as one can see from FIG. 11, this dependence is not quite exponential (the exponential dependence in a semi-logarithmic scale looks like straight line). The discrepancy can be explained by several factors:
influence of materials surrounding the detector and radioactive source (PVC, metallic and glass tubes) and absorbing some portion of radiation; and
distributed (non-point) nature of the source and the detector. The last factor is especially significant at small distances.

### Example 2

### Attenuation of Gamma-Radiation in air using a Co-60 Source

The next experiment was conducted using a Co-60 source of weaker activity than the Cs-137 used initially. The experimental data for the second experiment is presented in Table 4 and is illustrated in FIG. 11 too.

TABLE 4
Data of measurement of gamma radiation in the air from the
source #4 (Co-60) located at different distances from the detector.

| | | Peak | | | Distance | |
|---|---|---|---|---|---|---|
| Run | Time s | KeV | Peak HT | Area | mm | Rate |
| 1 | 491 | 1303 | 1242 | 72821 | 100 | 153.18 |
| 3 | 566 | 1295 | 525 | 24922 | 150 | 60.53 |
| 4 | 902 | 1269 | 593 | 12711 | 200 | 34.44 |
| 5 | 809 | 1289 | 368 | 17322 | 250 | 21.41 |
| 6 | 1965 | 1314 | 633 | 28624 | 300 | 14.57 |
| 7 | 2745 | 1294 | 666 | 26405 | 350 | 9.62 |
| 8 | 2014 | 1312 | 379 | 15703 | 400 | 7.80 |
| 9 | 1853 | 1308 | 326 | 10126 | 450 | 5.46 |
| 11 | 3389 | 1316 | 436 | 13440 | 500 | 3.97 |
| 10 | 7082 | 1311 | 856 | 18994 | 550 | 2.68 |
| 2 | 6044 | 1304 | 656 | 13636 | 600 | 2.26 |

### Example 3

### Attenuation of Gamma-Radiation in Water

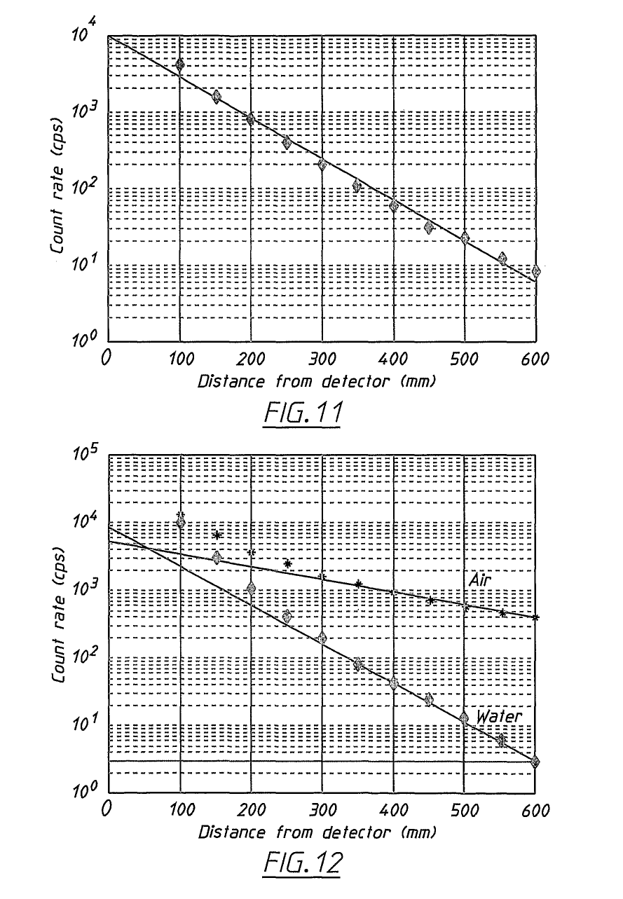

A similar experiment was conducted using the same apparatus with the laboratory tank filled in with water. The experimental data collected for these experiments is presented in Table 5 and in FIG. 12.

TABLE 5
Data of measurement of gamma radiation in the water from sources #3
and 3* (Co-60) located at different distances from the detector.

| | | Peak | | | Distance | |
|---|---|---|---|---|---|---|
| Run | Time s | KeV | Peak HT | Area | mm | Rate |
| 1* | 101 | 1257 | 9844 | 416726 | 100 | 4126.00 |
| 2* | 103 | 1280 | 3539 | 162411 | 150 | 1576.81 |
| 3 | 102 | 1279 | 3470 | 178990 | 150 | 1754.80 |
| 4 | 104 | 1292 | 1659 | 87526 | 200 | 841.60 |
| 5 | 109 | 1297 | 856 | 42764 | 250 | 392.33 |
| 6 | 122 | 1296 | 468 | 23806 | 300 | 195.13 |
| 7 | 112 | 1311 | 272 | 12285 | 350 | 109.69 |
| 8 | 204 | 1305 | 255 | 12147 | 400 | 59.54 |
| 9 | 379 | 1301 | 292 | 12115 | 450 | 31.97 |
| 12 | 473 | 1311 | 225 | 10233 | 500 | 21.63 |
| 11 | 819 | 1318 | 255 | 10165 | 550 | 12.41 |
| 10 | 1215 | 1313 | 234 | 10176 | 600 | 8.38 |

Since the density of water is closer in value to the density of the materials surrounding the detector and sources (PVC, metallic and glass tubes), the effect of these materials on the data obtained is not so pronounced. Therefore the dependence of count rate on distance, presented in FIG. 12, is very close to straight line.

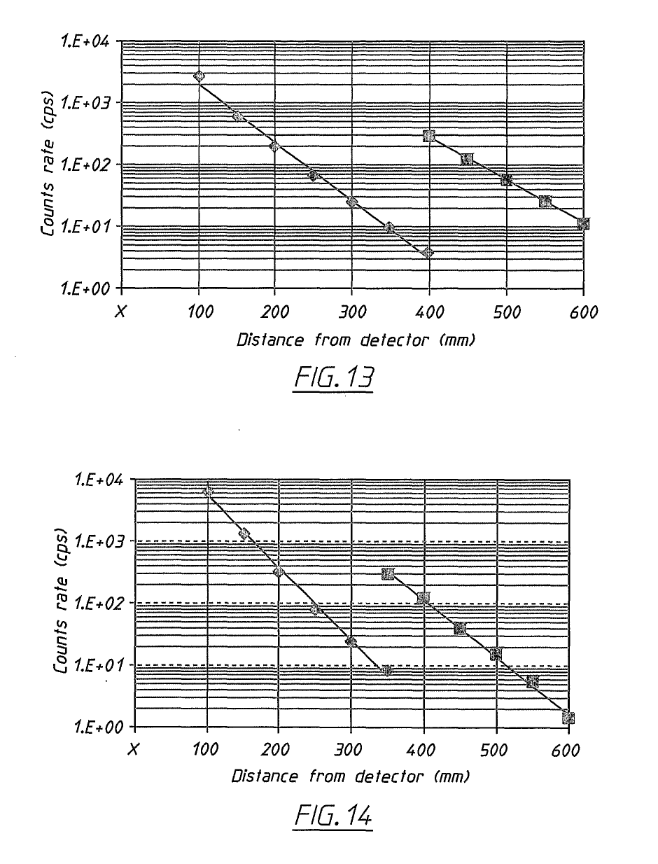

Another two experiments were conducted with a more powerful source of Cs-137 both in air and in water. Results obtained are presented in Table 6 and in FIG. 13.

TABLE 6
Data of measurement of gamma-radiation in the air and in water from
sources #5 (Cs-137) located at different distances from the detector.

| | Dis- | Air | | | | | |
|---|---|---|---|---|---|---|---|
| | tance | Time | | | Water | | |
| Run | mm | s | Area | Rate | Time S | Area | Rate |
| 1 | 100 | 100 | 1306448 | 13064.48 | 101 | 996549 | 9866.82 |
| 2 | 150 | 100 | 672802 | 6728.02 | 131 | 361555 | 2759.96 |
| 3 | 200 | 100 | 363663 | 3636.63 | 103 | 109622 | 1064.29 |
| 4 | 250 | 100 | 242440 | 2424.40 | 101 | 41756 | 413.43 |
| 5 | 300 | 100 | 163220 | 1632.20 | 129 | 24984 | 193.67 |
| 6 | 350 | 100 | 121794 | 1217.94 | 139 | 11296 | 81.27 |
| 7 | 400 | 100 | 92711 | 927.11 | 242 | 10243 | 42.33 |
| 8 | 450 | 100 | 73014 | 730.14 | 600 | 15334 | 25.56 |
| 9 | 500 | 100 | 59130 | 591.30 | 1200 | 15537 | 12.95 |
| 10 | 550 | 100 | 48551 | 485.51 | 3000 | 17486 | 5.83 |
| 11 | 600 | 100 | 40984 | 409.84 | 3260 | 10055 | 3.08 |

### Example 4

### Attenuation of Gamma-Radiation in River Sand

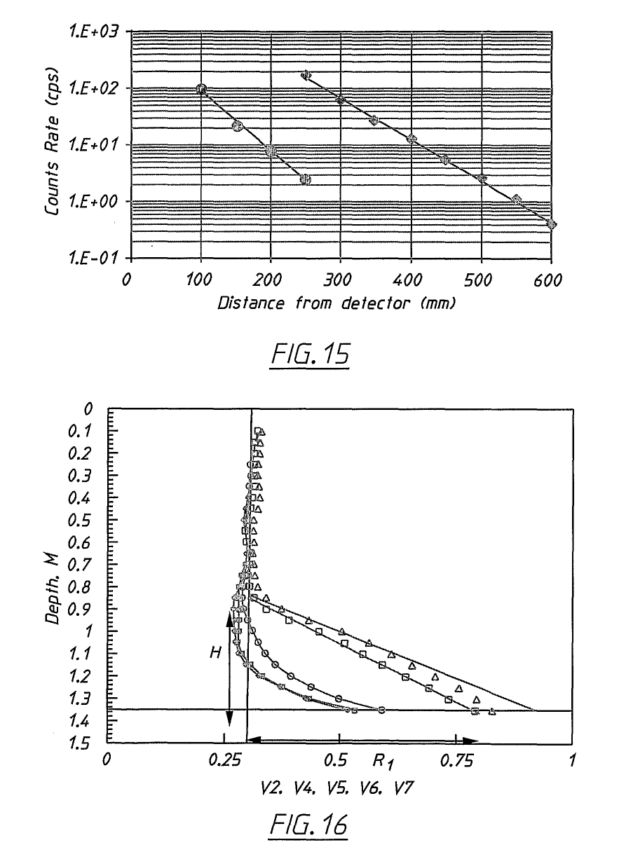

An experiment was conducted with measurements in river sand. The laboratory tank was filled in first with dry sand. Then, after series of measurements, water was added to the tank until the sand was completely filled in. After that, a new series of measurements were conducted with water saturated sand. Two radioactive sources Cs-137 with different intensity were used in both series of measurements. In experiments with water saturated sand two other sources of different intensity, Co-60, were used in addition to Cs-137. The results obtained are presented in Tables 7, 8, 9 and illustrated in FIGS. 14, 15 and 16.

TABLE 7
Data of measurement of gamma-radiation in dry sand from the
source #6 (Cs-137) located at different distances from the detector.

| Run | Isotope | ROI | Time s | Peak | Peak Ht | Area | Distance mm | Rate |
|---|---|---|---|---|---|---|---|---|
| 1 | Cs-137 | 598-680 | 100 | 634 | 8052 | 260437 | 100 | 2604.4 |
| 2 | (less) | | 100 | 634 | 1960 | 59038 | 150 | 590.4 |
| 3 | | | 100 | 639 | 679 | 19425 | 200 | 194.3 |
| 4 | | | 200 | 640 | 484 | 13427 | 250 | 67.1 |
| 5 | | | 500 | 639 | 514 | 12552 | 300 | 25.1 |
| 6 | | | 2000 | 634 | 860 | 19153 | 350 | 9.6 |
| 7 | | | 4000 | 633 | 957 | 16094 | 400 | 4.0 |
| 8 | Cs-137 | 598-680 | 100 | 637 | 1245 | 28646 | 400 | 286.5 |
| 9 | (more) | | 200 | 634 | 1070 | 24248 | 450 | 121.2 |
| 10 | | | 200 | 635 | 522 | 11504 | 500 | 57.5 |
| 11 | | | 500 | 633 | 591 | 13231 | 550 | 26.5 |
| 12 | | | 920 | 632 | 596 | 10691 | 600 | 11.6 |

TABLE 8
Data of measurement of gamma-radiation in water saturated sand from the source #6
(Cs-137) located at different distances from the detector.

| | | | | | | | Distance | |
|---|---|---|---|---|---|---|---|---|
| Run | Isotope | ROI | Time S | Peak | Peak Ht | Area | mm | Rate |
| 1 | Cs-137 | 563-662 | 103 | 600 | 1204 | 31683 | 350 | 307.6 |
| 2 | (hot) | | 104 | 607 | 496 | 12554 | 400 | 120.7 |
| 3 | | | 400 | 608 | 698 | 15644 | 450 | 39.1 |
| 4 | | | 1820 | 601 | 1421 | 28687 | 500 | 15.8 |
| 5 | | | 7000 | 599 | 2438 | 38242 | 550 | 5.5 |
| 6** | | | 7000 | 594 | 1249 | 10249 | 600 | 1.5 |
| 7* | Cs-137 | 563-662 | 100 | 608 | 17691 | 634900 | 100 | 6349.0 |
| 8 | (not-hot) | | 100 | 606 | 3825 | 129780 | 150 | 1297.8 |
| 9 | | | 100 | 602 | 1254 | 32189 | 200 | 321.9 |
| 10 | | | 200 | 593 | 763 | 16082 | 250 | 80.4 |
| 11 | | | 1500 | 596 | 1911 | 37082 | 300 | 24.7 |
| 12 | | | 6000 | 595 | 2835 | 50620 | 350 | 8.4 |

TABLE 9
Data of measurement of gamma-radiation in water saturated sand from the
source #7 (Co-60) located at different distances from the detector.

| Run | Isotope | ROI | Time s | Peak | Peak Ht | Area | Distance mm | Rate |
|---|---|---|---|---|---|---|---|---|
| 1 | Co-60 | 1133-1273 | 100 | 1202 | 354 | 17319 | 250 | 173.2 |
| 2 | (hot) | | 200 | 1200 | 285 | 13207 | 300 | 66.0 |
| 3 | | | 400 | 1191 | 241 | 10648 | 350 | 26.6 |
| 4 | | | 834 | 1206 | 259 | 10947 | 400 | 13.1 |
| 5 | | | 2000 | 1214 | 266 | 11415 | 450 | 5.7 |
| 6 | | | 10000 | 1198 | 741 | 26265 | 500 | 2.6 |
| 7 | | | 15000 | 1190 | 653 | 17224 | 550 | 1.1 |
| 8 | | | 20000 | 1206 | 531 | 8499 | 600 | 0.4 |
| 9 | Co-60 | 1133-1273 | 149 | 1193 | 282 | 14354 | 100 | 96.3 |
| 10 | (not-hot) | | 680 | 1195 | 316 | 14920 | 150 | 21.9 |
| 11 | | | 2000 | 1200 | 361 | 15692 | 200 | 7.8 |
| 12 | | | 5170 | 1188 | 374 | 13076 | 250 | 2.5 |

### CONCLUSION

The results obtained in the aforementioned examples show that
radioactive sources (Cs-137 and Co-60) are appropriate for the measurement of gamma radiation in different media (air, water, dry and wet sand) from remote sources up to distances of 600 mm and more;
the aforementioned radioactive sources can be used in similar media (gravel, clay, natural soil, etc);
the relationship between count rates and distance between the source and the detector is very close to exponential, which agrees with the theoretical predictions.

### Example 4

Below is an illustrative example based on a laboratory experiment conducted in a cylindrical tank 1.8m high×1.2m diameter. When salt water was injected into a porous material contained in the tank, it occupied a volume which had a quasi-conical shape of a height H and a basement radius R as shown in FIG. 16. The salt water volume was calculated using the formula V=πR²H/(3ε), where ε is the porosity of the medium. The volume V₁=6.0×10⁻³ m³ was known from the experiment. H=0.5 m was known from a measurement taken. Hence, the radius of the cone basement, say, at t=0 and (ε=0.4) was calculated to be as follows:

$${R}_{1} \sqrt{\frac{3 ɛ}{π} \frac{{V}_{1}}{H}} = \sqrt{\frac{3 \cdot 0.4}{π} \frac{6 \cdot {10}^{- 3}}{0.5}} = 6.77 \cdot {10}^{- 2} m . \qquad ( 25 )$$

At t=t₁=19 min after an additional volume ΔV=4.5 litre=4.5×10⁻³ m³ of salt water was injected into the tank porous material, the radius of a new cone at its base (assuming the same height H remained the same) was calculated to be:

$${R}_{2} \sqrt{\frac{3 ɛ}{π} \frac{{V}_{2}}{H}} = \sqrt{\frac{3 \cdot 0.4}{π} \frac{10.5 \cdot {10}^{- 3}}{0.5}} = 8.96 \cdot {10}^{- 2} m . \qquad ( 26 )$$

The equation describing the cone surface is

$$r = \sqrt{\frac{3 ɛ}{π} \frac{V}{H}} ( 1 - \frac{z}{H} ) . \qquad ( 27 )$$

Then, the distance between two water front positions at given height z is

$$\begin{matrix}Δ r = {r}_{2} - {r}_{1} \\ = \sqrt{\frac{3 ɛ}{π H}} ( 1 - \frac{z}{H} ) ( \sqrt{{V}_{2}} - \sqrt{{V}_{1}} ) .\end{matrix} \qquad ( 28 )$$

The radial velocity can be estimated as

$$\begin{matrix}v ( z ) = \frac{Δ r}{Δ t} \\ = \sqrt{\frac{3 ɛ}{π H}} ( 1 - \frac{z}{H} ) \frac{\sqrt{{V}_{2}} - \sqrt{{V}_{1}}}{Δ t} .\end{matrix} \qquad ( 29 )$$

The seepage velocity varies with the height and it reached a maximum value at z=0 which was calculated as follows:

$$\begin{matrix}v ( 0 ) = \frac{Δ r}{Δ t} \\ = \sqrt{\frac{3 ɛ}{π H}} \frac{\sqrt{{V}_{2}} - \sqrt{{V}_{1}}}{Δ t} \\ = 3.45 \cdot {10}^{- 5} m \text{/} s .\end{matrix} \qquad ( 30 )$$

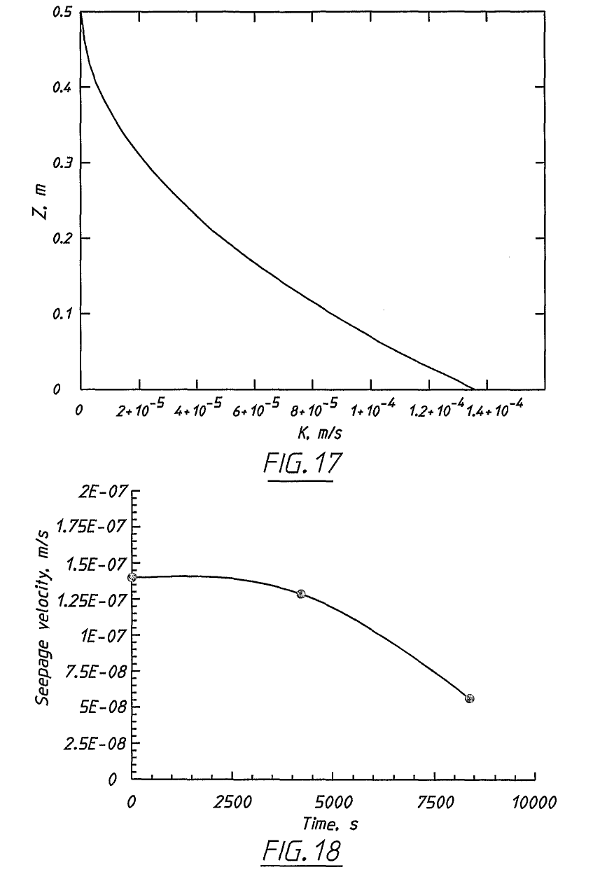

Assuming that the pressure head dropped from its maximum value at the axis r=0 to zero at the position of water front z=R, the hydraulic conductivity (FIG. 17) was estimated as follows:

$$\begin{matrix}K ( z ) = v ( z ) \frac{Δ r ( z )}{Δ Ψ} \\ = \frac{3 ɛ}{π H} {( 1 - \frac{z}{H} )}^{2} \frac{{( \sqrt{{V}_{2}} - \sqrt{{V}_{1}} )}^{2}}{Δ h Δ t} \\ = 1.36 \cdot {10}^{- 4} {( 1 - \frac{z}{H} ) }^{2} m \text{/} s\end{matrix} \qquad ( 31 )$$

where Ψ=Δz+p/(ρg) is the total pressure head.

### Example 5

Another illustrative example was based on a field experiment. At the beginning (at t=3.00 pm) some portion of salt water (volume V₁=0.005 m³) was injected into the ground through a borehole for 40 min. Assuming that the water was distributed uniformly within the cylindrical domain of the height H=15.7 m (between the depths z₁=2.4 m and z₂=18.1 m) and between radii R_{c}=0.06 m (radius of the borehole) and R₁, the radius R₁ (was calculated assuming the porosity ε was 0.4):

$$\begin{matrix}{R}_{1} = \sqrt{\frac{ɛ}{π} \frac{{V}_{1}}{H} + {R}_{c}^{2}} \\ = 0.06034 m .\end{matrix} \qquad ( 32 )$$

The average velocity of salt-water front propagation was calculated as follows:

$$\begin{matrix}{v}_{1} = \frac{{R}_{1} - {R}_{c}}{Δ {t}_{1}} \\ = \frac{0.00034}{Δ {t}_{1}} \\ = 1.4 \cdot {10}^{- 7} m \text{/} s .\end{matrix} \qquad ( 33 )$$

Then, another volume of water, V₂=0.0081 m³, was injected into the ground for Δt₂=70 min. It gave a new radius R₂ of the domain occupied by salt water:

$$\begin{matrix}{R}_{2} = \sqrt{\frac{ɛ}{π} \frac{{V}_{1} + {V}_{2}}{H} + {R}_{c}^{2}} \\ = 0.06088 m .\end{matrix} \qquad ( 34 )$$

The seepage velocity at this stage was estimated as:

$$\begin{matrix}{v}_{2} = \frac{{R}_{2} - {R}_{1}}{Δ {t}_{2}} \\ = 1.29 \cdot {10}^{- 7} m \text{/} s .\end{matrix} \qquad ( 35 )$$

One more volume of water, V₃=0.0036 m³, was been injected into the ground for another Δt₃=70 min. It gave a new radius R₃ of the domain occupied by salt water:

$$\begin{matrix}{R}_{3} = \sqrt{\frac{ɛ}{π} \frac{{V}_{1} + {V}_{2} + {V}_{3}}{H} + {R}_{c}^{2}} \\ = 0.06112 m .\end{matrix} \qquad ( 36 )$$

Hence, the seepage velocity at this stage was estimated as:

$$\begin{matrix}{v}_{3} = \frac{{R}_{2} - {R}_{2}}{Δ {t}_{3}} \\ = 5.67 \cdot {10}^{- 8} m \text{/} s .\end{matrix} \qquad ( 37 )$$

FIG. 18 shows the dependence of seepage velocity on time.

The hydraulic conductivity was estimated now on the basis of a known pressure head.

$$\begin{matrix}\begin{matrix}{K}_{1} = {v}_{1} \frac{{R}_{1}}{Δ {Ψ}_{1}} \\ = 1.36 \cdot {10}^{- 8} m \text{/} s .\end{matrix} \\ Similarly , & ( 38 ) \\ \begin{matrix}{K}_{2} = {v}_{2} \frac{{R}_{2}}{{ΔΨ}_{2}} \\ = 4.2 \cdot {10}^{- 9} m \text{/} s ,\end{matrix} \\ and & ( 39 ) \\ \begin{matrix}{K}_{3} = {v}_{3} \frac{{R}_{3}}{{ΔΨ}_{3}} \\ = 3.47 \cdot {10}^{- 9} m \text{/} s .\end{matrix} & ( 40 )\end{matrix}$$

The obtained values of hydraulic conductivity were compared with the data of direct measurements in the upper layers of the same borehole with the result Kₘₑₛ=7.83·10⁻⁸ m/s .

### Example 6

### Activatable Tracer

The calculation of hydraulic conductivity is also achieved in this example by the injection of an activatable tracer which has at least two different gamma energy emissions from neutron activation instead of the radioactive tracer as described in the previous examples using a technique known as prompt gamma neutron activation (PGNA). The further steps for the method for determining the distance from a reference point in the borehole to the activatable tracer and for determining hydraulic conductivity are then the same as for the radio-active tracer injection methods described above.

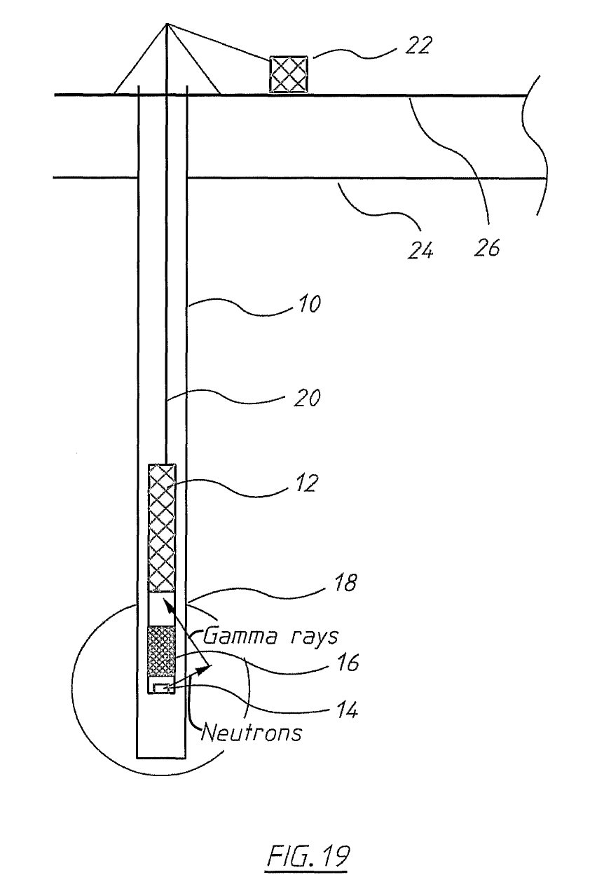

FIG. 19 shows a borehole (10) where an activatable tracer is used in accordance with the method, apparatus and spectral gamma ray logging tool of the invention. A container (12) includes a neutron source (14), a shielding (16) and a gamma radiation detector (18) located in the borehole (10). The neutron source (14) is located at a lower end of the container (12). The neutron source (14) in this particular embodiment is ²⁵²Cf. The neutron source (14) is surrounded by a shielding (16) which is located between the neutron source (14) and a gamma radiation detector (18). The gamma radiation detector (18) is connected by a cable (20) to a winch and data communication means (22) which allows transfer of data from the detector (18) to the data communication means (22). The cable (20) in this particular embodiment is a steel sheathed cable, which may be wound onto the winch (22) and allows for movement of the container (12) in an upward or downward direction in the borehole (10). The water table in the borehole (10) is shown by a line (24) and the ground surface by a line (26).

The neutron source (14), in use, activates many of the elements in the rock and pore-space water including Si, H, Al, Fe, etc. as well as any Cl present. The Cl may be present as dissolved NaCl. The full 480 channel gamma spectra at 10 cm increments up the bore hole may be measured. The relative abundance of each element may be measured by the number of counts from the gamma radiation detector (18) corresponding with the known energy region from the prompt gamma spectra. The gamma radiation detector may be a bismuth germinate (BGO) detector, a lanthanum bromide (LaBr₃Ce) detector, or a lanthanum chloride (LaCl₃Ce) detector, cadmium telluride, cadmium zinc telluride, sodium iodide, or a high purity germanium HPGe detector.

In use, the calculation of desired parameters including the hydraulic conductivity is achieved by the injection of an activatable tracer which has at least two different gamma ray energy emissions from neutron activation. The steps of calculating the hydraulic conductivity are then the same as described for the previous radioactive tracer examples of the invention.

In this example, NaCl is injected into the borehole (10) to provide activatable Cl⁻ ions which have multiple gamma ray emission energies. The neutron source (14) then activates the Cl⁻ ions which emit the gamma radiation emissions which is then detected by the detector (18). The detector (18) sends data via the cable (20) to the data communication means (22) where the gamma spectral data is transferred to a computer for gamma spectral analysis, determination of elemental abundance and further calculations of the invention in a similar manner as for the radioactive tracer of the invention.

Another variation of this example for underground formations which have a high salt content may be to inject water into the borehole (10) and dilute the amount of salt which is then activated by the neutron source (14) as described above.

An advantage of using NaCl is that it is inexpensive and Cl⁻ ion is relatively chemically benign. It is also observed that Cl⁻ has multiple strong gamma ray emissions when neutron activated together with a relatively large neutron cross-section, which in turn leads to a low concentration detection limit. Cl⁻ ion is also not often present in significant concentrations in the rock but as a dissolved salt and is environmentally benign at the volumes and concentrations required for the method of the invention.

If necessary the bulk of the activatable tracer could be recovered from the borehole after tracer injection and logging, by simply pumping out the bore fluid and allowing the tracer to flow back into the bore. The detector (18) is able to detect approximately 0.1 to approximately 0.5% Cl⁻ as compared to a detection limit for Si and Fe of about 5%.

Whilst this example describes the use of NaCl, it should be appreciated many other activatable tracers are also able to be used, including but not limited to potassium chloride, manganese chloride, sodium sulfate, potassium sulfate, sodium bromide or potassium bromide amongst other salts.

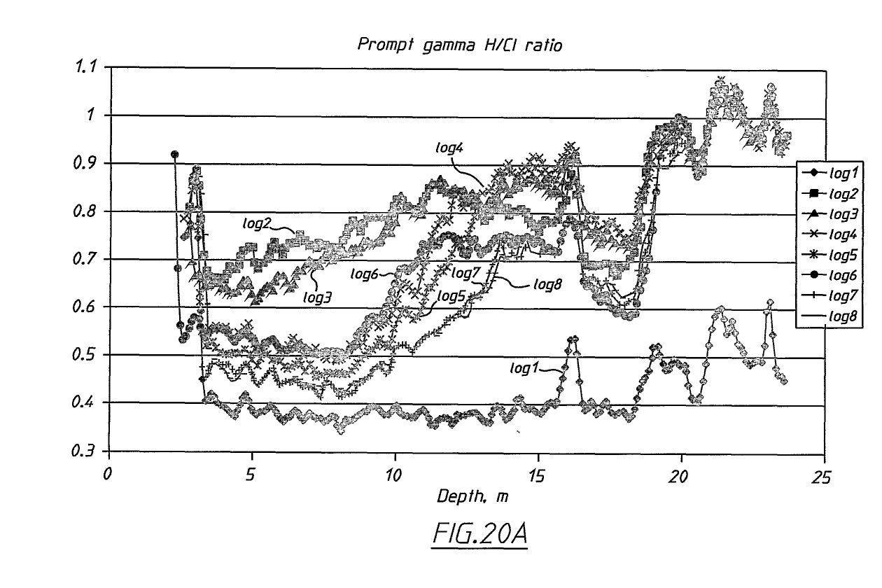

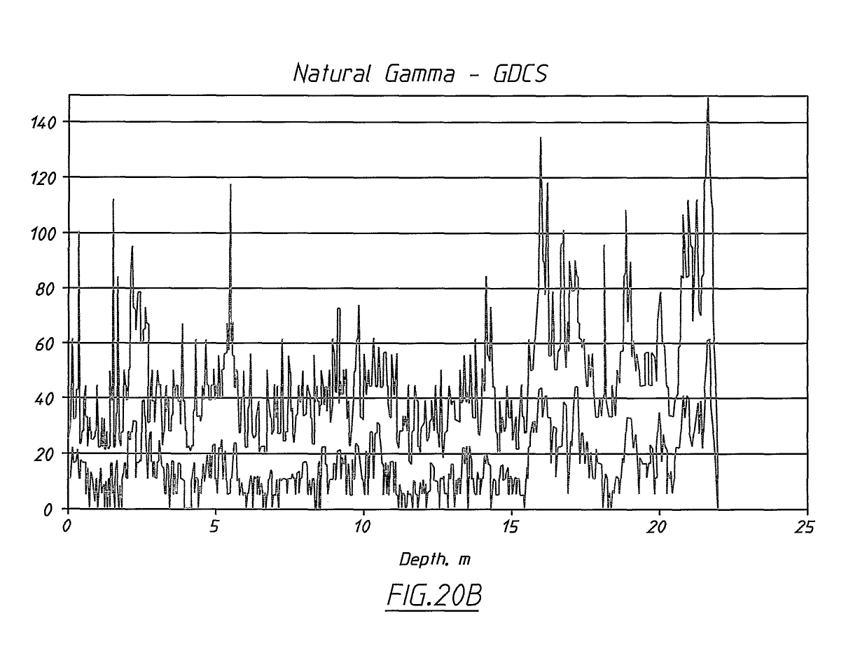

FIG. 20A and FIG. 20B shows real data collected from a borehole of a NaCl tracer injection experiment from MW6 at the Australian Nuclear Science and Technology Organisation (ANSTO) Lucas Heights, Sydney Australia. It should be noted that the figures should be rotated so that the right hand side is the bottom of the 25 m deep bore and the left hand side is the ground surface.

FIG. 20A shows the log of relative H/Cl (counts in single gamma spectral region corresponding to H and Cl) prior to NaCl tracer injection in the line labelled log 1, then as more NaCl tracer is injected followed by water to push the NaCl tracer further into the porous rock, as the other lines in the diagram (log 2, log 3, log 4, log 5, log 6, log 7 and log 8). All of the volume and concentration and pressure head difference for injection of a NaCl solution with time was noted. In practice this injection data is then used in the hydraulic conductivity calculation together with the relative abundance up the bore hole of the tracer, in this case it is presented as a single Cl energy measurement.

FIG. 20A graphs real data collected from a bore of a NaCl tracer injection experiment from MW6 at Australian Nuclear Science and Technology Organisation (ANSTO).

FIG. 20B shows the corresponding log of depth (m) against total counts from natural gamma radiation (U, Th, K) in borehole MW6a. The corresponding log of total gamma counts per second vs depth (m) from natural gamma radiation is for the same bore hole as for FIG. 20 (a) i.e. MW6. The total natural gamma radiation detected in bores is mostly due to a combination of U, Th, and K radioactive isotopes commonly occurring in rocks.

The relative variance in distance of the activatable tracer is able to be calculated from the variation up the bore hole of Cl at energy ˜1.95 MeV and also Cl at energy ˜6.1 MeV. It is to be noted that there are many complexities involved in improving the gamma spectral analysis, particularly the software for quantification. However, it is believed that the example illustrates all the important components of the measurement apparatus and activatable NaCl tracer injection necessary for the hydraulic conductivity calculation.

Step-by-Step Calculation of a Hydraulic Conductivity from the Data of Field Measurements

### Step 1

It is supposed that the data of field measurements of gamma-radiation purified from the background is available as a function of depth, z: i.e., the intensity of gamma-radiation (count rate) at a given excitation energy, E, can be presented in the form I=f(z). This function can be presented as:

TABLE 10
Intensity of gamma-radiation as a function of depth.

| | Count rate at | Count rate at | Count rate ratio at |
|---|---|---|---|
| Depth, z (m) | energy E₁ | energy E₂ | energies E₁ and E₂ |
| 2.5 | 297.21 | 283.28 | 0.9531 |
| 2.6 | 526.72 | 345.76 | 0.6564 |
| 2.7 | 607.65 | 349.54 | 0.5752 |
| . . . | | | |

### Step 2

As shown, the intensity of gamma-radiation measured by the detector at the fixed depth, zᵢ, depends on the effective length, l, over which the radiotracer is distributed. In the simplest case of a uniform distribution of a radioactive material in the total intensity registered by the detector at a given excitation energy, Eᵢ, is determined by means of:

$${I}_{tot} ( l ) = \frac{M}{μ l} ( 1 - {e}^{- μ l} ) {e}^{- t l n 2 / τ} , \qquad ( 41 )$$

where μ(E) is the attenuation factor which depends on the excitation energy E; l is a distance over which the radiotracer is distributed; M is an unknown parameter—the density of the distribution; and τ is the half-life time of radioactive material.

Considering the responses of the detector at two excitation energies (which are available from the multi-channel detector), E₁ and E₂, and taking a ratio of signals at these energies (see Table 10), one obtains

$$\begin{matrix}R ( l ) ≡ \frac{{I}_{tot}^{1} ( l )}{{I}_{tot}^{2} ( l )} \\ = \frac{{μ}_{2}}{{μ}_{1}} \frac{1 - {e}^{- {μ}_{1} l}}{1 - {e}^{- {μ }_{2} l}} .\end{matrix} \qquad ( 42 )$$

This formula allows us to calculate the effective distance l.

### Step 3

The effective distance, in a first approximation, is proportional to the seepage velocity, l=Vt, where t is the time lapsed from the beginning of a solute pumping to the borehole. The seepage velocity, V, is determined by Darcy law

V=−K(∇p+ρg∇z), (43)

where K(z) is the hydraulic conductivity of the considered layer, ∇p is a pressure gradient, ρ is the solute density, g is the acceleration due to gravity, and ∇z is a unit vector directed downward.

Hence, one can conclude that the effective distance l is proportional to the hydraulic 5 conductivity K: the larger the conductivity the longer the path covered by the radiotracer for the given time.

### Step 4

The effective distance l can be calculated by means of Equation (42). That formula represents a transcendental equation with respect to l if the ratio of count rates is preliminary calculated and presented in Table 10. Thus, one more column in Table 10 can be created which contains calculated values of l for each particular value of depth, zᵢ. Data in that column may be treated as the relative hydraulic conductivity K.

### Step 5

To obtain an absolute value of the hydraulic conductivity, one needs to have only one independent measurement of the hydraulic conductivity at any fixed point by means of different method. This provides a calibration for the hydraulic conductivity.

Another calibration may be done by comparison of an average hydraulic conductivity for the entire borehole obtained by this method and any independent measurement. Having data of the relative hydraulic conductivity at N depth levels, one can calculate their average value. Comparing this value with any independent measurement of average hydraulic conductivity one can readily determine a coefficient of proportionality between these two averaged values. Then, the data for relative hydraulic conductivity should be multiplied by this coefficient resulting in the absolute values of hydraulic conductivity.

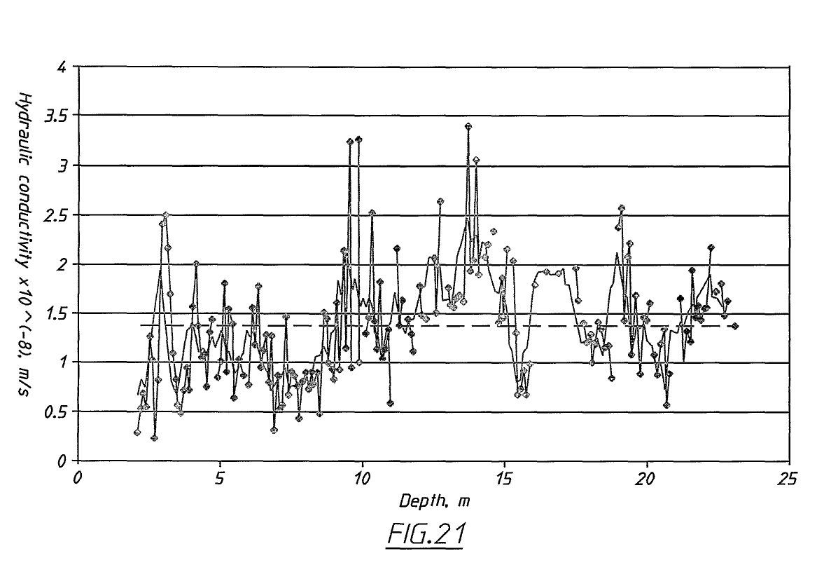

FIG. 21 shows a graph of the depth (m) against the Hydraulic Conductivity (×10⁻⁸ m/s) for the activatable tracer example described above.

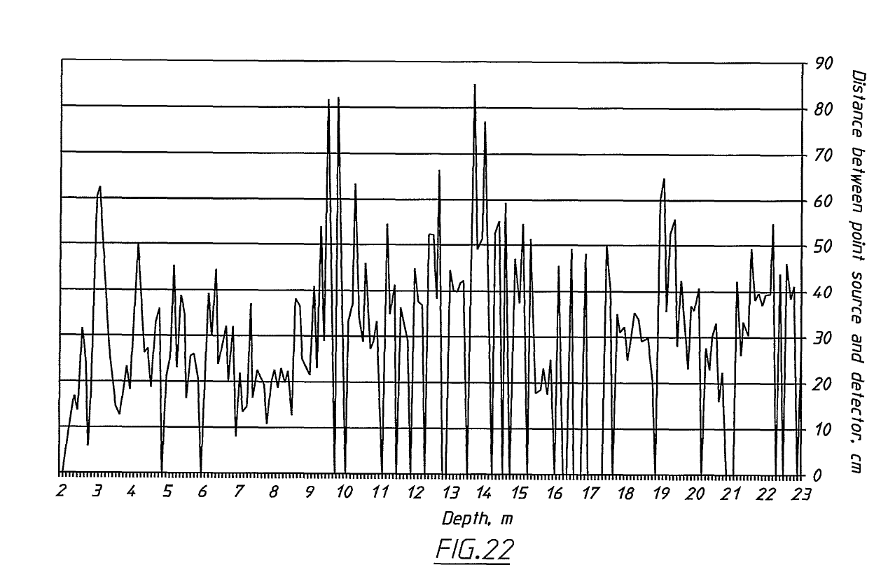

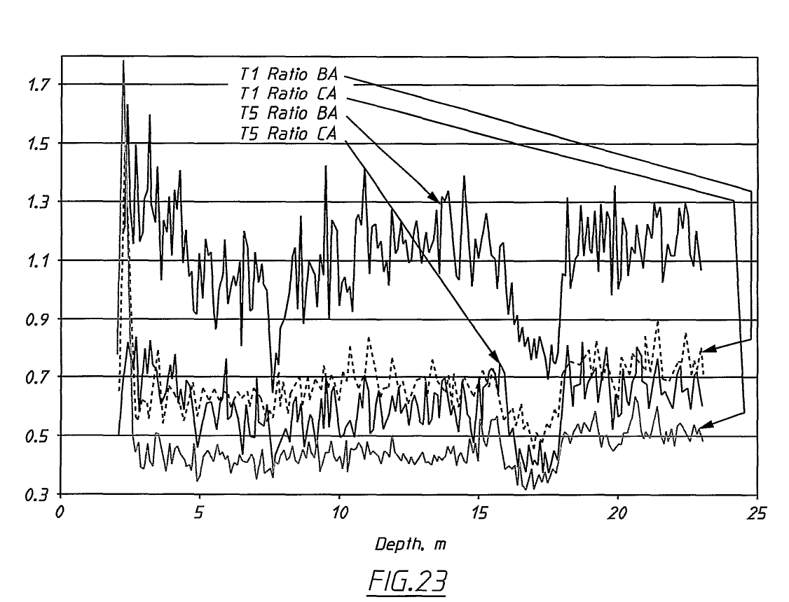

FIG. 22 shows a graph of the depth (m) against the distance between point source and detector (cm) for the activatable tracer example described above. The data on this graph is based on the assumption that the distance is measured from the centre of the detector and the activatable tracer is assumed to be an average distance which is an average of concentration distribution function. The distributed concentration function is approximated by a point source in point source distances to source vs. depth.

FIG. 23 shows a graph of the depth (m) to the ratio of the gamma peaks for A, B and C for the activatable tracer example as shown in FIG. 19. The Aₚₑₐₖ is at 1.95 MeV, the Bₚₑₐₖ is at 6.1 MeV and the Cₚₑₐₖ is at 7.4 MeV. Two different tracer injection steps are shown, at time 1 (T1) the initial measurement of Cl energies A, B, and C and the ratios B/A and C/A are plotted. Similarly, after time step 5 (T5) by injection of more NaCl tracer another measurement of the Cl energies A, B, C and ratios B/A and C/A are plotted. After each injection of more NaCl tracer solution the tracer has moved relatively further away from the borehole. Subsequently a choice of tracer distance can be optimised for calculation of hydraulic conductivity.

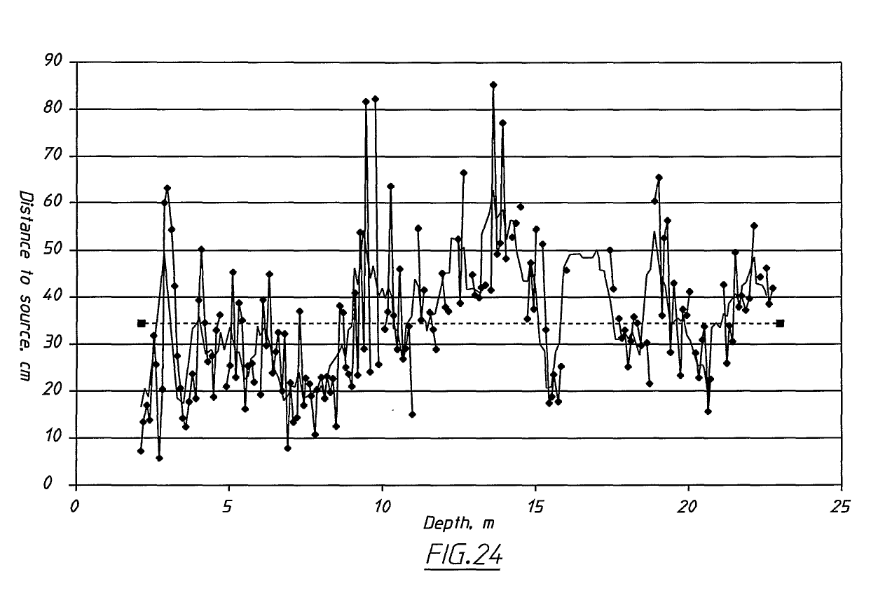

FIG. 24 shows a graph of the depth (m) against the distance to source (cm) for the activatable tracer example described above. It should be noted that the distance to source (cm) measurement as shown in this graph is related to the hydraulic conductivity. It should also be noted that the graph shown in FIG. 24 is based on an assumption of a 60 mm diameter detector where the distance is measured from the centre of the detector and has a height of 60 mm. The borehole diameter space is also assumed to be 100 mm in diameter.

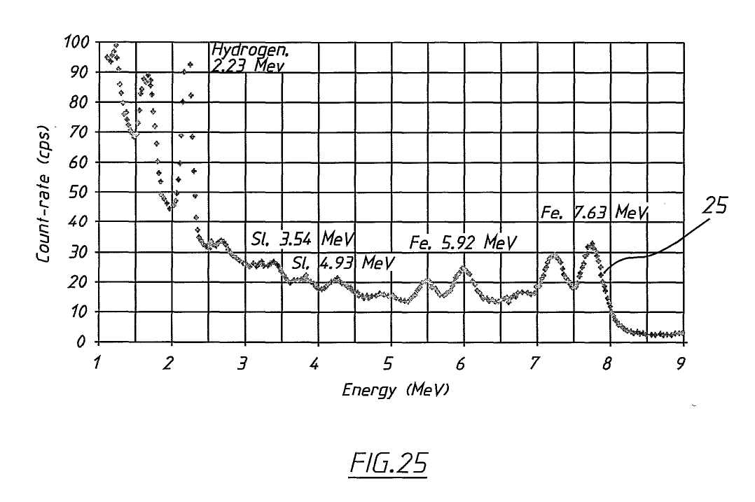

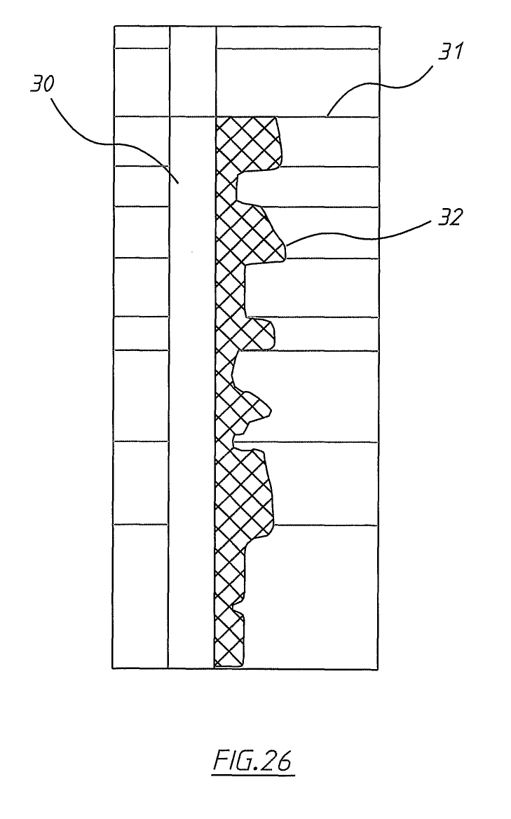

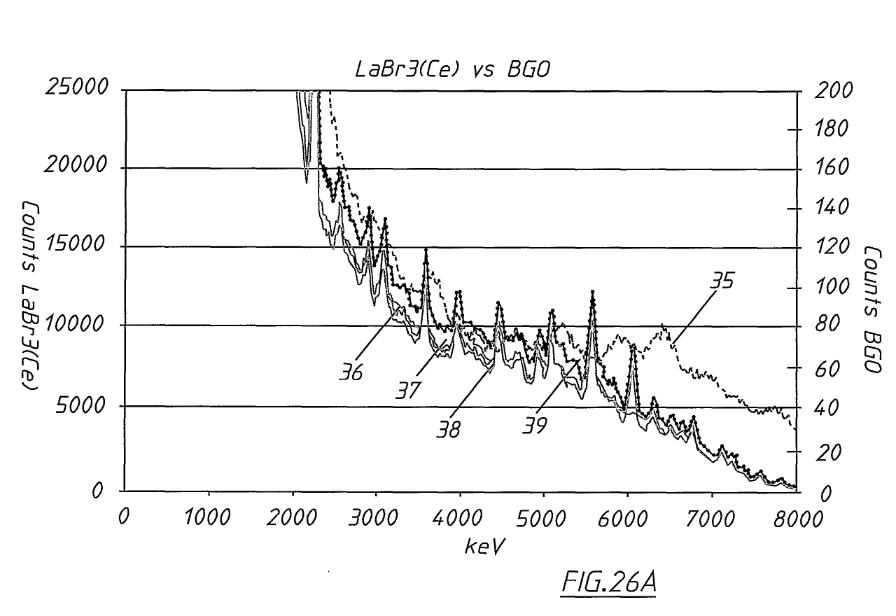

FIG. 25 shows an example count spectrum obtained from a single PGNA spectrum 25 recorded in iron ore showing characteristic neutron activated response peaks from various elements found in the borehole. The detector used for this measurement was a BGO gamma radiation detector. To fully characterize a borehole, the PGNA logging device is moved along the full depth of the borehole and gamma radiation measurements taken incrementally. This allows the hydraulic conductivity (among other parameters) to be determined for the full depth of the bore as shown schematically in FIG. 26, which can then enable a full stratigraphic correlation of a borehole 30 (with water table 31) with respect to the tracer penetration/hydraulic conductivity 32. This full stratigraphic correlation correlation with respect to the hydraulic conductivity can then enable improved groundwater flow models.

FIG. 26A shows comparison PGNA spectra using a BGO gamma radiation detector (plot 35) with spectra obtained using a lanthanum bromide LaBr₃Ce gamma radiation detector (plots 36, 37, 38 and 39). The BGO gamma radiation spectra is offset to the right of the graph of FIG. 26A. It is clear from this graph that the use of a lanthanum bromide gamma radiation detector (and similarly for lanthanum chloride LaCl₃Ce detector, cadmium telluride detector, cadmium zinc telluride detector, sodium iodide scintillation detector, or high purity germanium HPGe detectors) provides many orders of magnitude increase in the signal-to-noise (i.e. the number of counts detected), allowing for much greater sensitivity of the gamma radiation detection. Thus, these detectors enable selection from a variety of gamma radiation spectral peaks with much greater sensitivity for improved differential count analysis for determination of the hydraulic conductivity. Other advantages of the present system using a lanthanum bromide, or lanthanum chloride detector, cadmium telluride, cadmium zinc telluride, sodium iodide, or high purity germanium HPGe gamma radiation detectors include an ability to select various individual peaks for the element of interest and the ability to sum the total counts from various selected elemental peaks to improve the elemental detection signal-to-noise.

### Procedures for Hydraulic Conductivity Measurement

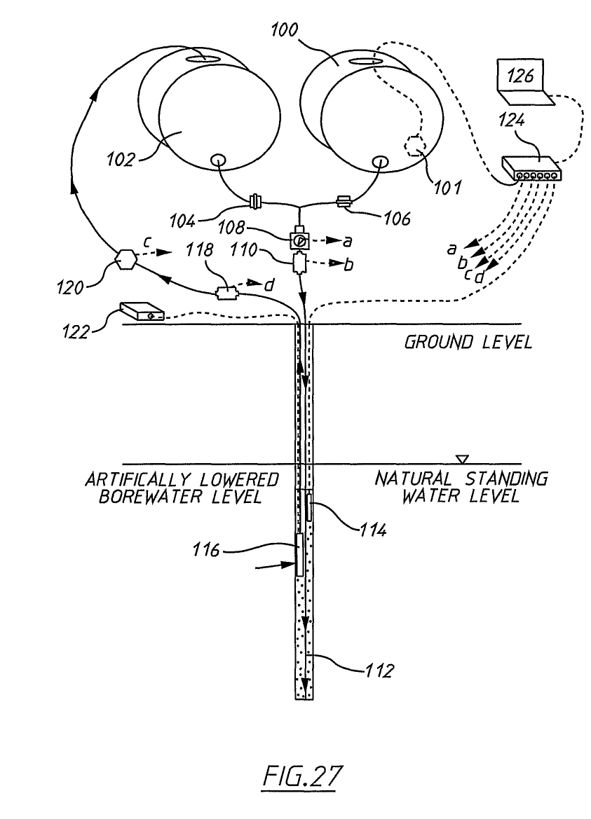

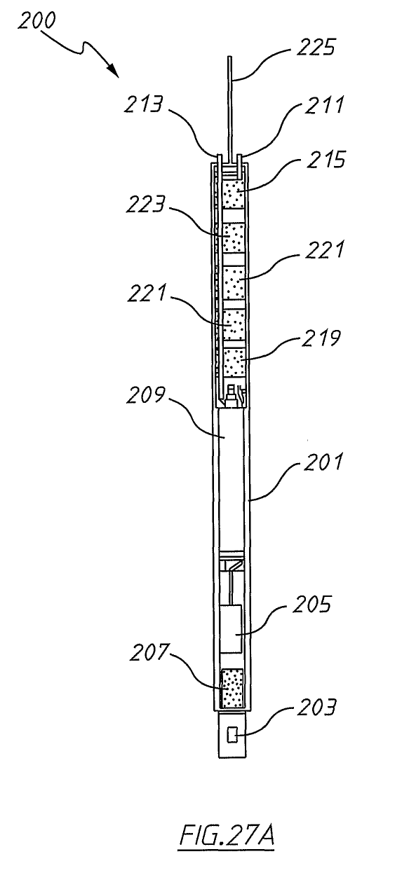

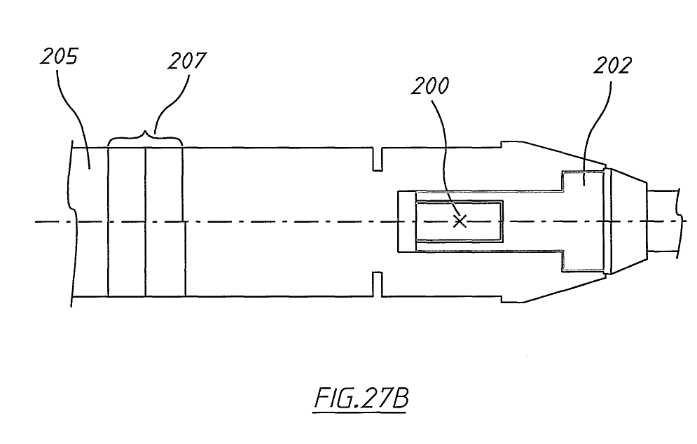

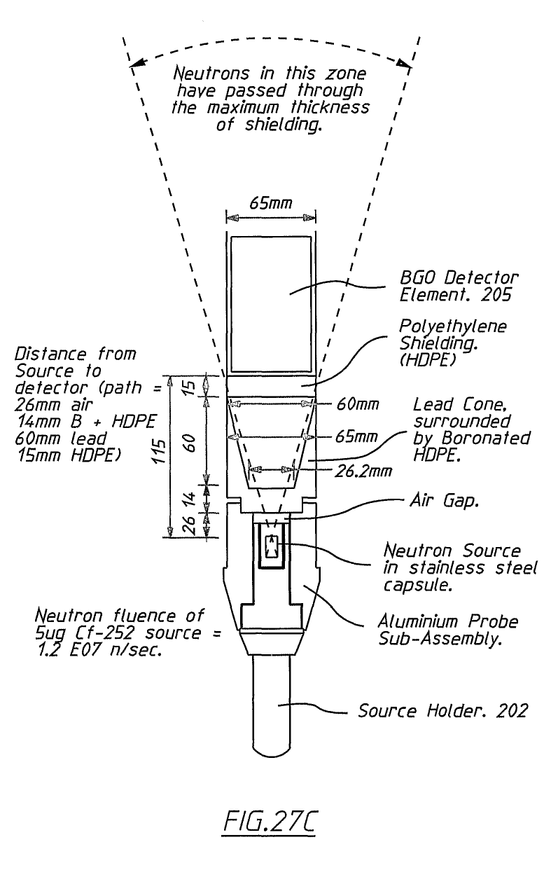

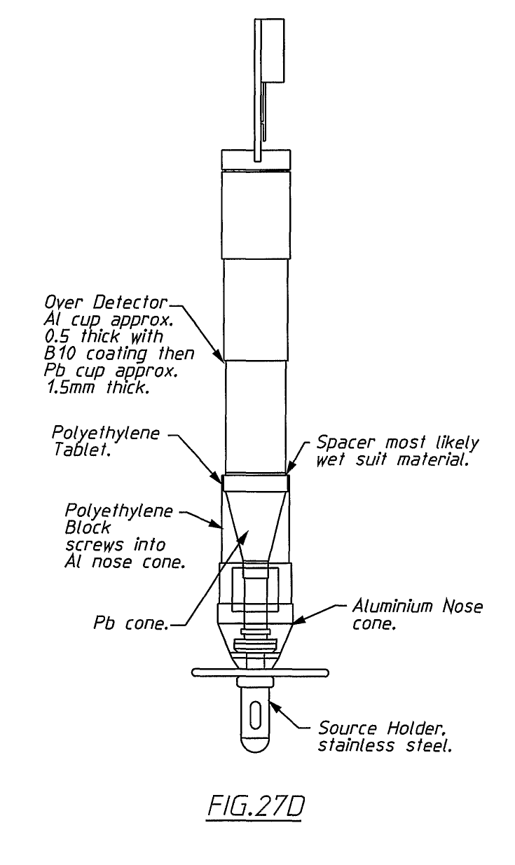

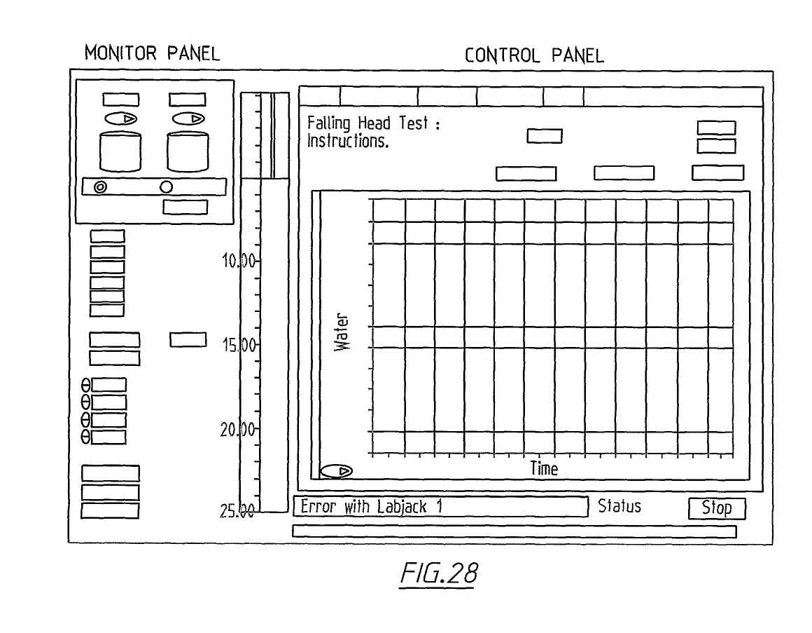

In alternative arrangements, the hydraulic conductivity can be determined using a prompt gamma neutron activation (PGNA) logging device such as that depicted in FIG. 27 which is a schematic of an example arrangement of a tracer injection and control system including the PGNA logging tool described in Example 6 above for automatically controlling, monitoring and recording borehole tracer injection parameters such as flow rate, water level and salinity as well as recording the PGNA spectrum. The system is applied in a borehole to create conditions of tracer distribution which are favourable for neutron logging in the PGNA system.

Referring to FIG. 27 the system comprises a first fluid storage tank 100 for storage of the tracer solution, for example a salt water solution (e.g. NaCl) and a second fluid storage tank 102 for storage of water extracted from the borehole. The fluid storage tanks may have a fluid storage capacity of about 500 L or more. A conductivity sensor 101 is placed in the tracer tank 100 to monitor the salinity of the tracer solution. Valves 104 and 106 are attached to outflow ports of the tanks 100 and 102. The valves 104 and 106 are then connected to a motorised valve 108 which can be automatically controlled to adjust the composition of fluid from the tracer tank 100 and the bore eater tank 102. A flow meter sensor 110 is connected on the output side of the motorised valve 108 to monitor the flow rate of fluid through the motorised valve and into the borehole through injection hose 112. A pressure sensor 114 is held below the artificially lowered bore water level to monitor the pressure of the fluid in the borehole. An example pressure sensor may be a LS-10 Submersible Pressure Transmitter available from WIKA Alexander Wiegand GmbH. Example conductivity sensors 101 and 120 may be microCHEM GK10 Conductivity Transmitter available from TPS Pty Ltd. Flow sensors 110 and 118 may be 33110 Low Flow Sensors available from Cole Parmer. Motorised valve 108 may be for example a 12V Motorised Valve available from KZCO.

A pump 116 is held in the borehole to pump bore water out of the borehole through flow meter sensor 118 and bore conductivity meter sensor 120 and into bore water tank 102. An example pump may be a GRUNDFOS MP1 Groundwater Pump available from Grundfos Pumps Corporation. Bore conductivity meter sensor 120 is used to monitor the salinity level of the bore water as it is pumped out of the bore hole. The pump is controlled by pump controller 122, an example of which may be REDIFLO Variable Speed Pump Controller available from Grundfos Pumps Corporation.

The sensors 101, 110, 114, 118 and 120 and motorised valve 110 are connected to a data acquisition card via a circuit board mounted in an interface box 124. An example data acquisition card may be a Labjack UE9 Data Acquisition Card available from Labjack Corporation. The pump may optionally be connected to the data acquisition card, or the operator may elect to control the pump manually, hence allowing many types of pumps to be used.

The data acquisition card is operated via software on computer 126. In one arrangement of the system, the software may be written with a flow control programming language such as LabVIEW™ for example. The software may be used to start, stop or change the rate of tracer/borewater input and output. The software controls the valve 110 and pump 120 together with information from the pressure, conductivity and flow sensors to control the amount of head in a borehole, thus determining when, how long, how fast and how saline tracer injection occurs.

Broadly, the operation of a tracer injection and recordal of PGNA spectra may comprise the following steps:
Preliminary neutron log(time 0);
(Optional) Falling Head using fresh water to establish rate of injection;
Mix tracer in to borehole while maintaining a density-neutral SWL;
Inject tracer into rock by raising the SWL with more tracer;
Remove (or ‘unmix’) tracer from borehole water column and replace with fresh water, while maintaining a density-neutral SWL;
Neutron log(time 1);
(Optional) Push tracer further into rock, by raising SWL with more fresh water;
(Optional) Neutron log(time 2);

More specifically, the tracer injection and control system and PGNA logging device may be used for both constant concentration and mixed concentration measurements (similar to the “Uniform Distribution” case and the “Fast Injection” cases respectively as described above). For each case, the equipment required for the hydraulic conductivity measurement includes at least two tracer tanks on the surface for storage of the tracer, which for example may be a salt such as NaCl. In some case more tanks may be required. The storage capacity of the tanks may be approximately 250 to 1000 L as desired, but generally the tanks have a storage capacity of approximately 500 L each.

Tracer mixing and injection control and monitoring equipment is also required comprising:
A computer module comprising control software for controlling the components of the device, and serial communications to a hardware controller linked to the components of the PGNA logging device. The computer module may also be configured to receive data from the detector and other components [specify] and calculate the hydraulic conductivity.
Electrical conductivity meters (typically two).
Flow controller.
A bore pump for example a Grundfos pump.

FIG. 27A shows an example arrangement of a PGNA borehole logging device 200. The device 200 comprises an outer casing 201, which may in some arrangements be formed from a carbon fibre material, steel or other suitable material as would be appreciated by the skilled addressee. Housed within the casing is a neutron source 203 which in the present arrangement is a fixed or passive neutron source, although in other arrangements, the neutron source may be an activatable neutron source generator which may be activated remotely from the surface. In alternate arrangements, the neutron source may be housed in a separate housing (for example housing 202 of FIG. 27B) which is releasably engagable with the logging device 200. The advantage of having a releasable source housing is that it may be stored and handled separately to the remaining components of the logging device and only installed in the device 200 just prior to insertion into the borehole, thereby enabling the logging device to be handled safely, and the operator is only exposed to a radiation dose (in the event of the source being a fixed neutron source).

A gamma radiation scintillation detector 205 is housed within the casing and shielded from the neutron source 203 by shielding 207 so that the detector only detects gamma radiation originating from the borehole surroundings. The detector 205 may be selected from the group of a bismuth germinate BGO detector, a lanthanum bromide LaBr₃Ce detector, or a lanthanum chloride LaCl₃Ce detector, cadmium telluride, cadmium zinc telluride, sodium iodide, or a high purity germanium HPGe detector. Where the detector requires cooling, for example via liquid nitrogen (N₂), the logging device 200 also comprises a liquid N₂ dewar 209 for storage of the N₂, and liquid N₂ filling port 211 and vent 213, and a N₂ gas pump/non-return valve 215. The present arrangement of the logging device also houses power supply, analysis and control modules for example an energy/spectral bandwidth selection module 217 for selection of the gamma radiation detection energies for subsequent analysis, a power supply 219 such as a high voltage power supply, a multi-channel analyser module 221 for analysis of the selected gamma radiation energies which are detected by the detector 205, and data/control communications module 223 for receiving commands from and transmitting recorded data to the surface control and monitoring equipment. The logging device is suspended in the borehole by steel cable 225 which also comprises power and communications wiring between the borehole logger and the surface.

### Constant Concentration Method

The objective of this experiment is to measure the PGNA spectral response before and after tracer injection. The tracer injection procedure described has two stages”
A First stage of mixing to a uniform concentration the tracer (salt) solution in the bore as well as in the surface tank whilst maintaining the constant equilibrium SWL. Compensation for density change is required.
A second stage injection step applies a head pressure to the solution in the bore by draining tracer from the surface tank to effect the injection.

After the tracer has been injected into the rock surrounding the bore the bore is logged by the PGNA logging equipment. Multiple steps of tracer injection followed by PGNA logging are possible to observe incremental change of tracer movement. The tracer may also be pumped out from the bottom of the bore and replaced by fresh water at constant static/standing water level is (SWVL) (with density compensation), which in effect, is the mix stage described below in reverse. Further addition of fresh water acts to push the tracer further into the rock allowing measurement biased to tracer signal further from the detector.

### Monitoring and Prediction Prior to Experiment

The steps to be undertaken prior to measurement of the hydraulic conductivity include (but are not limited to):
Measurement of the equilibrium SWL in the bore.
Installation of a pressure (P) sensor below the SWL.
Calculate the bore water volume.
Calculate the water volume in a 20 cm annulus around the bore. This calculation should include the porosity of the rock surrounding the bore, for example Hawkesbury Sandstone is assumed to have a porosity of approximately 5-10%.
Calculate the mass of salt (i.e. the activatable tracer material) required to mix the bore and rock water volume at constant concentration, for example approximately 5%.
Conduct simple falling head test (pressure vs flow rate) to calculate the approximate time required to inject the tracer and the pressure head and to calculate/estimate the average hydraulic conductivity (HC).

Determine the background levels of activatable material in the bore with PGNA and Natural before mixing and injection of the tracer.

Step 1—Mixing

Replace the bore water with salt water to a constant concentration and constant bore pressure (not equal to the SWL). As the salinity of bore increases, the density will increase proportionally, therefore it is necessary to reduce the SWL by the same percentage as the density increase to maintain a no flow condition (i.e. constant pressure) whilst mixing.

Next, whilst monitoring the electrical conductivity of the water in the bore, replace the bore water with salt water by pumping out the bore water from bottom to Tank A and replacing with salt water from Tank B to the top of the bore. The volume of salt water in Tank B is then the bore water volume plus the tracer injection volume.

When the electrical conductivity rises sharply due to the injection of the salt water, the submerged pump switch is switched to pump water from Tank B back into the bore to circulate salt water from Tank B until concentration fluctuations are negligible.

Step 2—Inject

The injection process comprises the injection of half of the available tracer volume into the bore as rapidly as possible. One method of achieving this is by the following procedure:
2(a). Turn off the submersible pump and rapidly drain the salt tracer into the bore to achieve a target head height in the bore.
2(b). Reduce the salt tracer flow from the tank to maintain the head at the target height.
2(c). When half of the tracer volume has been injected, stop the flow of the tracer to the bore and rapidly pump out the bore water back to SWL (minus the required percentage adjustment for the density/porosity correction).
2(d). Log bore with PGNA.
2(e). Repeat steps 2 (a)-2(d) for the remaining half of the tracer in Tank B. Note that additional water injection steps may be required if there is loss of tracer along fractures in the bore.
2(f). Log bore with PGNA.

### Step 3—Remove Injected Salt Water

To remove the salt water injected into the bore, the following procedure can be followed:
3(a). Use the submersible pump to remove the same volume of water into Tank B as was initially injected.
3(b) Measure the electrical conductivity of the bore water. It should be same as tracer concentration.
3(c) Whilst monitoring the electrical conductivity and the volumes pumped, repeat Steps 3(a) and 3(b) until the salt concentration in the bore is less than about 1%.

To avoid loss of tracer into the rock above the SWL, a single packer can be used at the SWL and the packer Grundfos pump and pressure monitoring equipment can be used. This is important for shallow boreholes where the additional head for injection is a large proportion of the total.

### Experiment 2 Procedure Mixed Concentration

The objective of this experiment is to measure the PGNA spectral response before and after tracer injection. The tracer injection procedure described has two stages:
A First stage of mixing to a uniform concentration the tracer solution in the bore whilst maintaining the constant equilibrium SWL. Compensation for density change is required.
A Second stage injection step applies a head pressure to the solution in the bore by draining water from a surface tank to effect the injection.

The water drained to the bore must be evenly mixed throughout the bore injection interval. The even distribution and mixing between water and tracer during injection is achieved by an injection tube with numerous small perforations along its length. After the tracer has been injected into the rock surrounding the bore the bore is logged by the PGNA logging equipment. Multiple steps of tracer injection followed by PGNA logging are possible to observe incremental change of tracer movement with incremental dilution of the tracer in the bore. Each further addition of fresh water will push the tracer further into the rock allowing measurement biased to tracer signal further from the detector.

Monitoring and Prediction prior to Experiment

The steps to be undertaken prior to measurement of the hydraulic conductivity include (but are not limited to):
Measurement of the equilibrium SWL in the bore.
Installation of a pressure (P) sensor below the SWL.
Calculate the bore water volume.
Calculate the water volume in a 20 cm annulus around the bore. This calculation should include the porosity of the rock surrounding the bore, for example Hawkesbury Sandstone is assumed to have a porosity of approximately 5-10%.

Calculate the mass of salt (i.e. the activatable tracer material) required to mix the bore and rock water volume at constant concentration, for example approximately 10%.
Conduct simple falling head test (pressure vs flow rate) to calculate the approximate time required to inject the tracer and the pressure head and to calculate/estimate the average hydraulic conductivity (HC)
Determine the background levels of activatable material in the bore with PGNA and Natural before mixing and injection of the tracer.

### Step 1—Mixing

Replace the bore water with salt water to a constant concentration and constant bore pressure (not equal to the SWL). As the salinity of bore increases, the density will increase proportionally, therefore it is necessary to reduce the SWL by the same percentage as the density increase to maintain a no flow condition (i.e. constant pressure) whilst mixing.

Next, whilst monitoring the electrical conductivity of the water in the bore, replace the bore water with salt water by pumping out the bore water from top to Tank A and replacing with salt water from Tank B to the bottom of the bore.

The volume of salt water in Tank B is then the bore water volume.

When the electrical conductivity rises sharply due to the injection of the salt water, the submerged pump switch is switched to pump water from Tank B back into the bore to circulate salt water from Tank B until concentration fluctuations are negligible.

### Step 2—Inject

The injection process comprises the injection of half of the available tracer volume into the bore as rapidly as possible. One method of achieving this is by the following procedure:
2(a). Turn off the submersible pump and rapidly drain the salt tracer into the bore to achieve a target head height in the bore.
2(b). Reduce the salt tracer flow from the tank to maintain the head at the target height.
2(c). When half of the tracer volume has been injected, stop the flow of the tracer to the bore and rapidly pump out the bore water back to SWL (minus the required percentage adjustment for the density/porosity correction).
2(d). Log bore with PGNA.
2(e). Repeat steps 2 (a)-2(d) for the remaining half of the water in Tank B. Note that additional water injection steps may be required if there is loss of tracer along fractures in the bore.
2(f). Log bore with PGNA.
2(e) repeat steps 2 (a-d) for the remaining ½ water volume in Tank B.
2(f) Log bore with PGNA

To avoid loss of tracer into the rock above the SWL, a single packer can be used at the SWL and the packer Grundfos pump and pressure monitoring equipment can be used. This is important for shallow boreholes where the additional head for injection is a large proportion of the total. is Computer module

In an example arrangement, the system may be operated by control software on computer 126 (of FIG. 27) for controlling the components of the device and to automatically perform the various steps and calculations describe above. An example arrangement is shown in FIGS. 28 to 40.

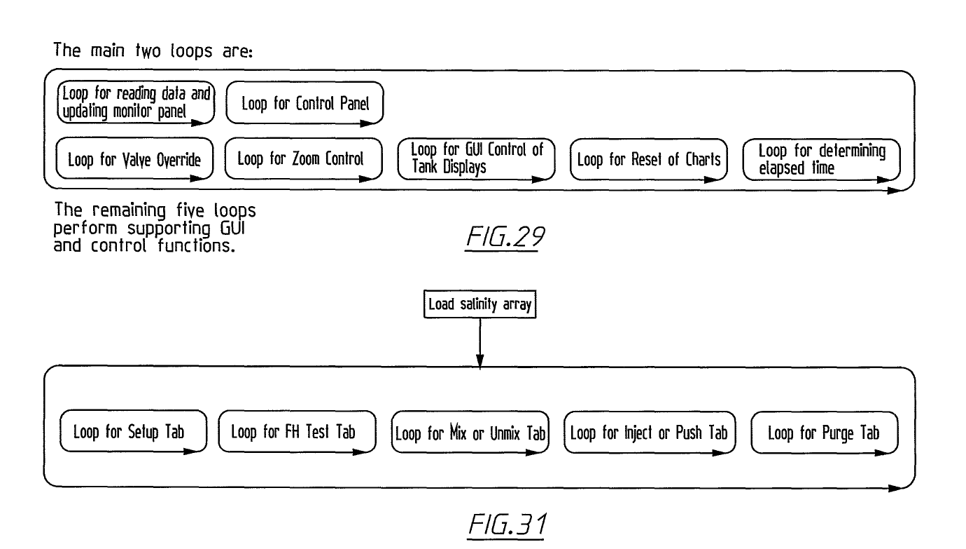

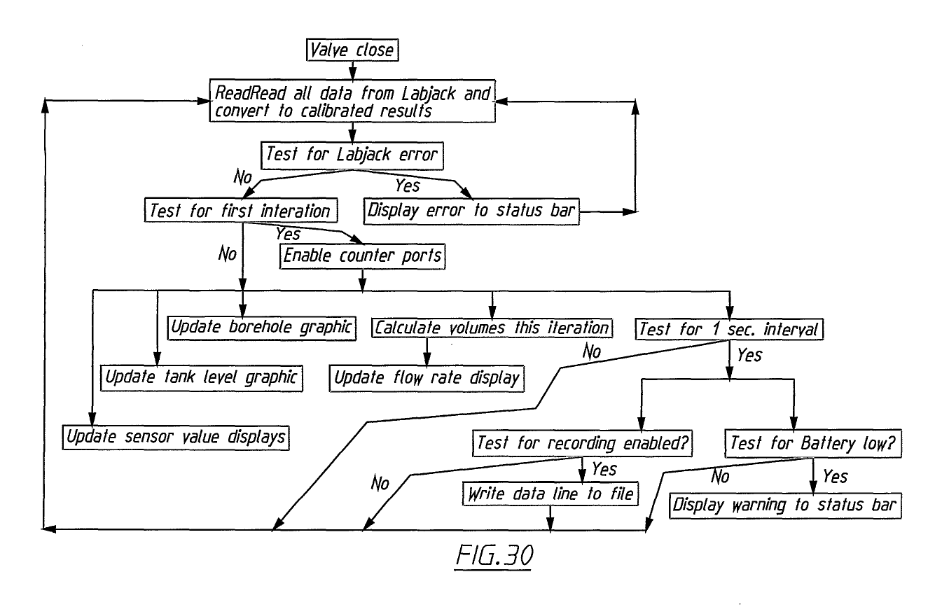

FIG. 28 shows a screen shot of the main interface parameter of the present arrangement of the LabVIEW™ control software user interface, which consists of two main panels: (a) the monitor panel, which is updated with information from the sensors continuously; and (b) the control panel, which the operator uses to control the various stages of tracer injection. The control panel consists of five tabs, ‘Setup’, ‘Falling Head Test’, ‘Mix or Unmix’, ‘Inject or Push’, ‘Purge’, the operation of each are described below. FIG. 29 shows a schematic of the main routines of the control software, which in the present arrangement is organised in 7 loops which execute continuously while the program is open.

The monitor panel is updated twice a second as per the loop flow diagram of FIG. 30 and consists of the following components:
A tank level monitor graphic, the operator selects which tank is connected for bore input and which for bore output, and sets the tank initial fill level. Each tank graphic is updated during operation using volume data from the flow sensors.
Borehole monitor graphic, which displays the initial resting standing water level, and updates the current borewater level using data from the pressure sensor.
Sensor value displays for flow rate in and out, cumulative volume in and out, and salinity in and out.
Controls for sensitivities and tolerances of the pressure sensor, conductivity sensors, valve and pump.
Controls for changing the range of the borehole monitor to zoom in and out.
Controls for the motorised valve.
Job start time, elapsed time per stage, power supply voltage.

The Control panel comprises the five control loops of FIG. 31 for each of the available interface tabs, where each loop is only operational when the respective tab is visible.

### Setup Tab

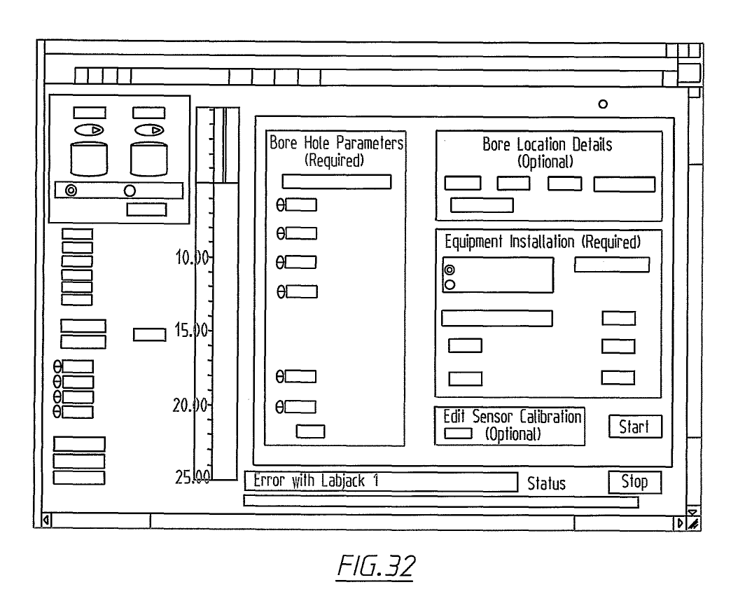

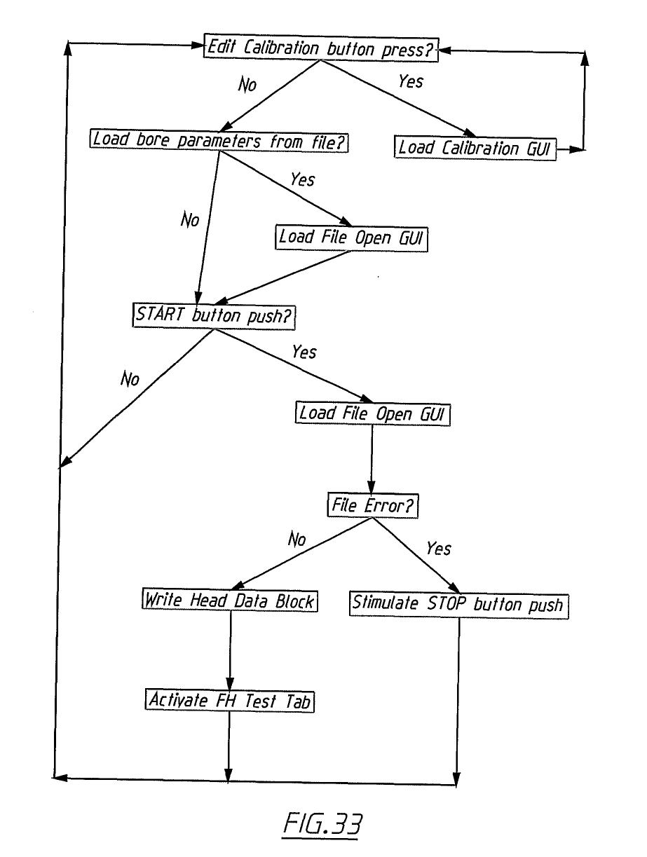

When initially started, the software starts in the setup interface tab as depicted in the present arrangement by FIG. 32 which operates as per loop flow diagram of FIG. 33. In this tab, the operator is able to enter bore details, (e.g. bore depth, resting standing water level) and equipment installation details (e.g. pressure sensor type and depth, tank capacity). This information is saved to the header of a tracer log file which periodically stores information from each of the sensors. If saved previously, the details may be loaded from the header of an existing file. An interface for editing the calibration parameters of the sensors if required is also provided in the present arrangement.

When the operator is ready to precede, the START button press will write the header data to file. A new file may be started, or data may be appended to an existing file as a new block. The program will progress to the next tab.

### Falling Head Test Tab

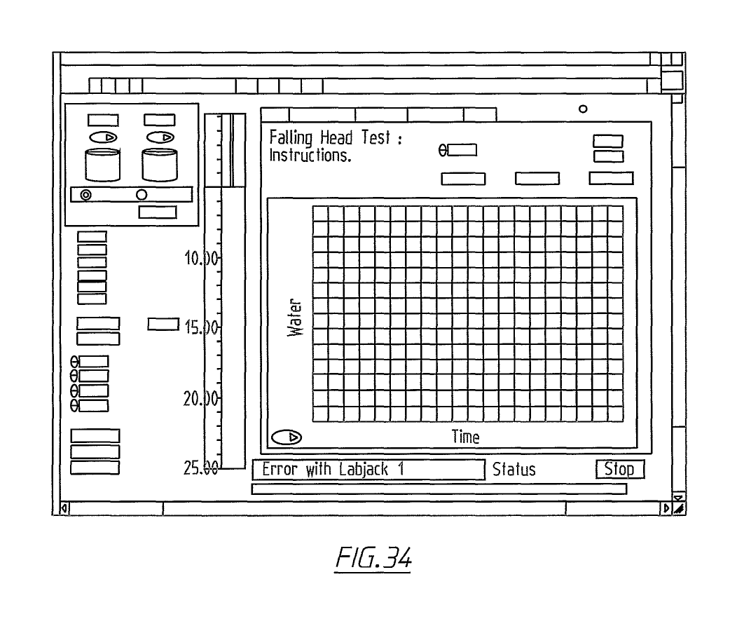

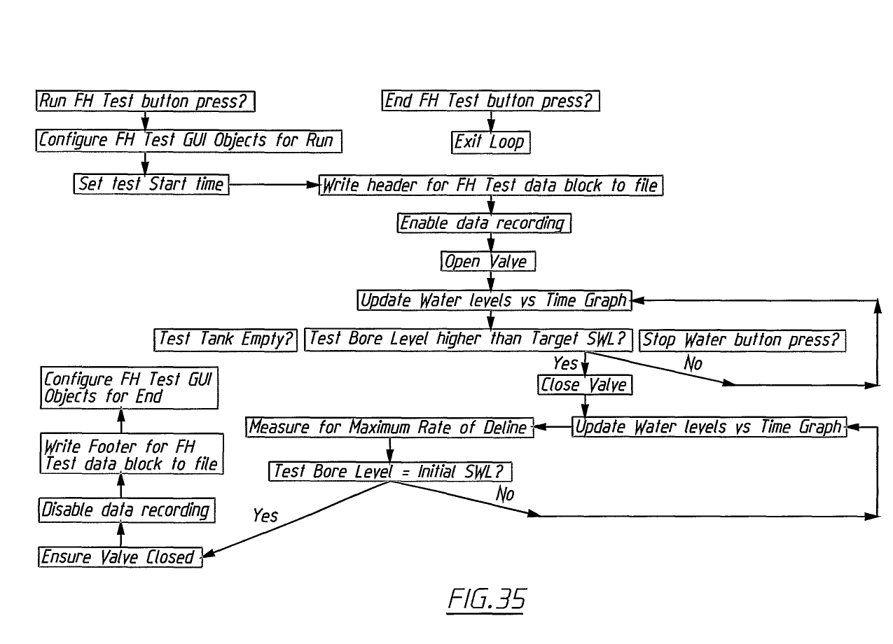

To conduct a Falling Head (FH) Test prior to commencement of any experiments, the operator selects the FH Test interface tab of the control software depicted in the present arrangement by FIG. 34, which operates as per loop flow diagram of FIG. 35. The operator then manually connects a storage tank containing fresh water (not shown) to the valve 110, and enters the amount of head to add to well, then presses the Start FH Test button to begin recording. The software will then open the valve to siphon water into the well until the specified head condition is reached according to the pressure sensor. Initial SWL, current borewater level and target head are plotted on the graph once per second. All sensor data is recorded to file once per second. The software continues to record and plot until the water level relaxes back to the initial SWL, or the End FH Test button is pressed. The operator may also elect to turn off the water below the target head. Data from this test may be used to estimate overall hydraulic conductivity of the well. Also the maximum rate of Head Decline is recorded for use in the later injection step.

### Mix Or Unmix Tab

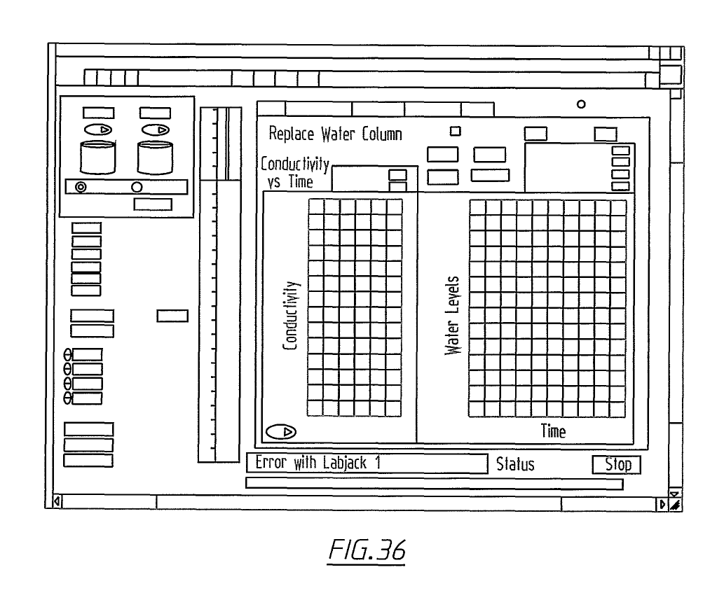

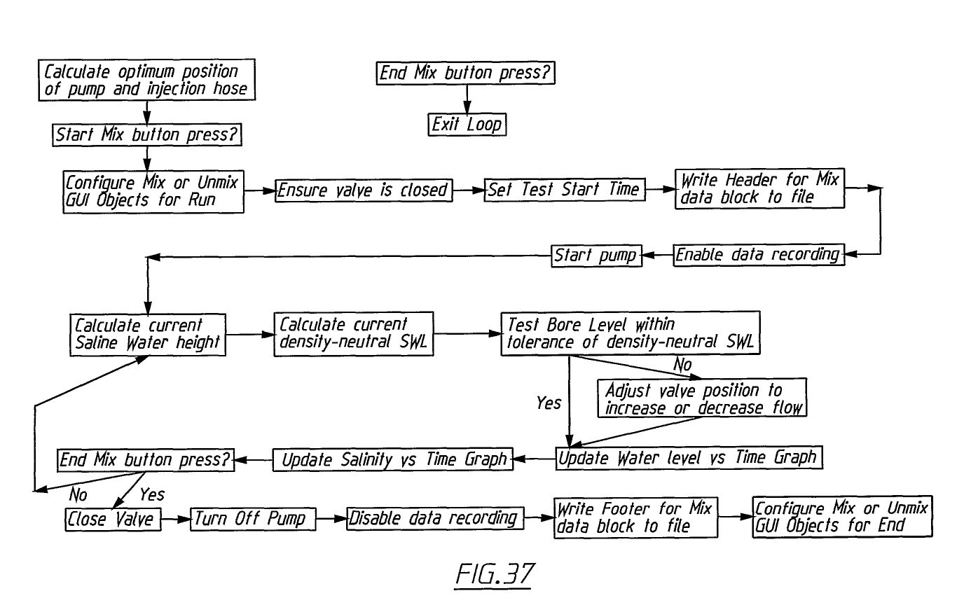

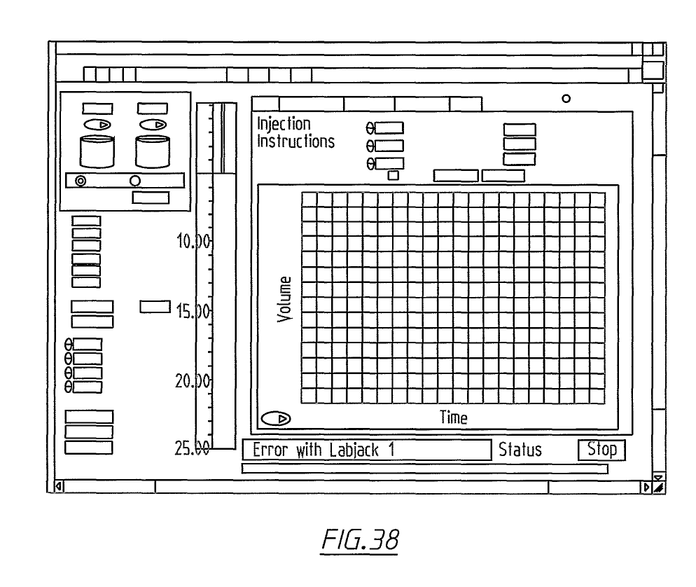

The Mix/Unmix tab, depicted in the present arrangement by FIG. 36, which operates as per the loop flow diagram of FIG. 37 is used at two stages during the operation, firstly to mix the tracer in to the borehole prior to injection, secondly to remove or unmix the tracer from the borehole water column after injection and prior to logging.

The operator selects which direction to mix the tracer, and the software instructs the optimum position for the pump and injection hose. Note the pressure sensor must also be installed at the lesser depth shown. The operator then enters the name of the tracer used for the file header, and its concentration in the tank, then the start Mix button is pressed.

In the case of mixing tracer in, the software will start the pump (or instruct the operator to start the pump if manually operated), to begin removing fresh borewater from near the top of the well, and open the valve to begin siphoning tracer into the bottom of the well. In this way the salt water column height gradually increases from the base of the well up. In order to prevent premature injection, the valve is continuously adjusted by the software to maintain the correct standing water level in the bore. The standing water level is gradually reduced as the salt water column grows, to counteract the greater density of the salt water and prevent it from being injected prematurely. During the process, all sensors are recorded to file. Conductivity is plotted to the left hand graph, and the water levels are plotted to the right hand graph.

In the case of unmixing the tracer out after injection has occurred, the heights of the injection hose and pump must be changed so that the salt water is pumped out from the base of the well, as fresh borewater is added back in near the top. The standing water level is gradually raised back to natural level during this process as the salt water column shrinks. This is to maintain a steady tracer position in the surrounding rock medium after injection has taken place.

This routine will continue to operate until the End Mix button is pressed.

### Inject Or Push Tab

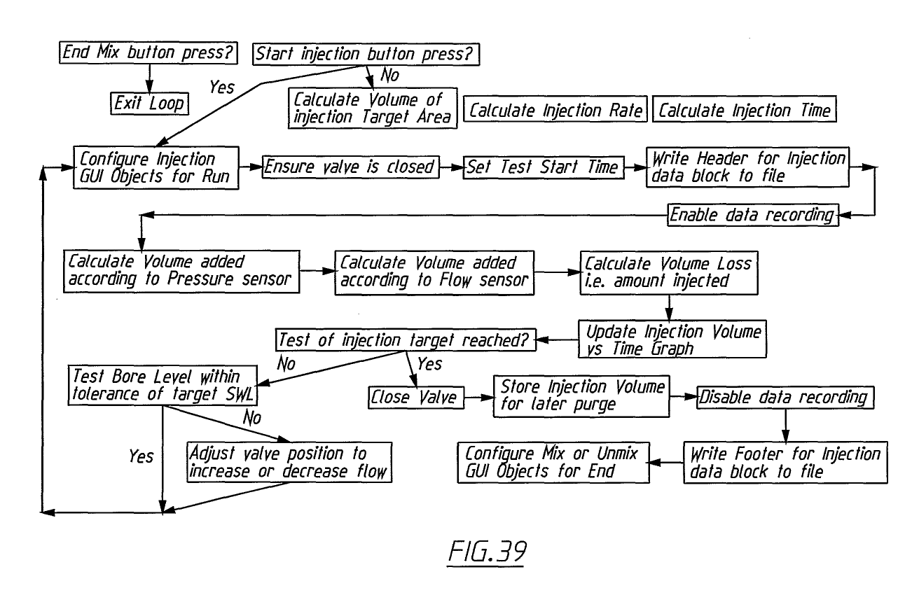

In this routine, depicted in the present arrangement by FIG. 38 which operates as per loop flow diagram of FIG. 39, the operator enters an estimate of borehole porosity, the target distance beyond the borehole to inject the tracer, and the amount of head to add above the natural SWL to perform the injection. The software will display a calculated injection rate based on the previous maximum rate of decline from the Falling Head test. It will also display the injection volume and time required to achieve the target distance.

The operator also selects whether tracer is injected or fresh water.

On Start Injection button press, all of this information is saved to the header of a new data block in the file, and sensor data is recorded to file once per second. The software adds more tracer to the well to raise the borewater tracer level up to natural SWL and beyond it to the specified additional head. The amount of water injected is measured by flowmeter and the routine will stop when the calculated injection volume is reached or the End Injection button is pressed.

### Purge Tab

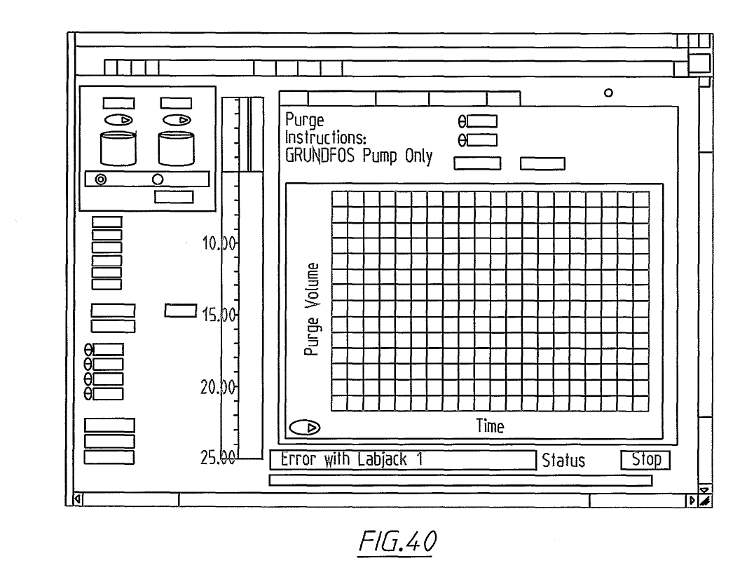

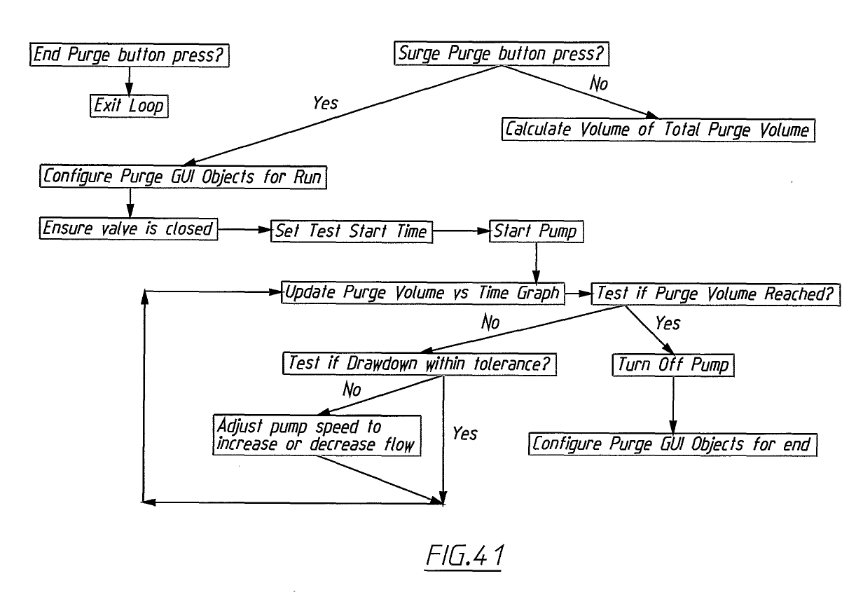

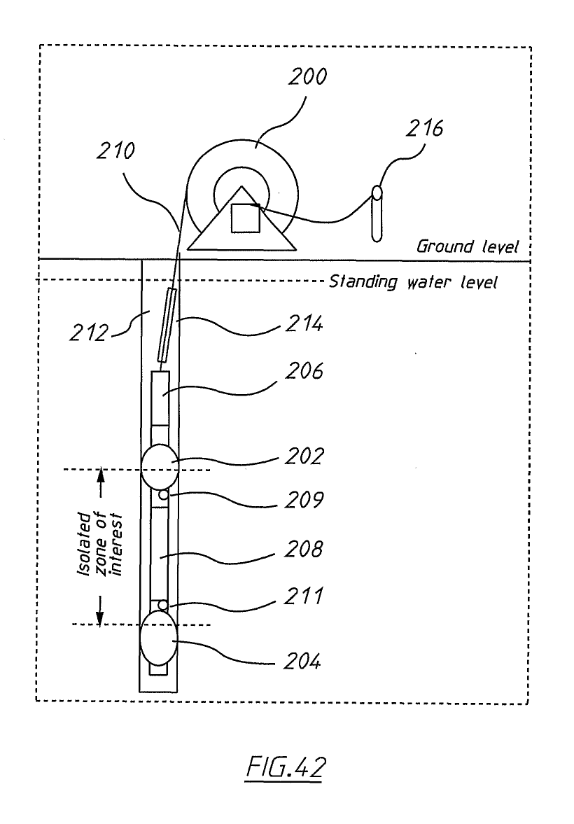

A fifth tab, depicted in the present arrangement by FIG. 40 which operates as per loop flow diagram of FIG. 41, is included to purge salt water from the borehole and rock medium after testing is concluded.

### Example 7

FIG. 42 shows a schematic diagram of a down-hole, isolated zone-of-interest groundwater sampler (DIZOIGS) for discrete interval borehole sampling and/or injection of solutions which may be used in combination with the PGNA logging devices described above to enable zone-of-interest isolation capabilities to the hydraulic conductivity measurement device. The zone of interest may be a discrete zone anywhere along the length of the borehole, or alternately the zone-of-interest may simply be either the top or bottom section of the borehole.

The DIZOIGS utilises two inflatable cylindrical packers and a large reel that can be in installed above and below the zone of interest (ZOI) to isolate that section of the borehole from waters outside the ZOI.

Sampling from or injection of solutions into unscreened boreholes is often complicated by the array of groundwater flow paths that contribute to inflow to and outflow from the borehole. This means that a sample taken from a particular level in the borehole will have contributions from various, often unknown points above and below. Conversely, during injection of (e.g.) saline solutions, large quantities of injection fluid may be lost through fractures or porous strata outside the ZOI. To minimise these complications and losses, it is desirable to isolate the ZOI from the remainder of the borehole.

Portable inflatable packers are constructed with a hollow metal core and surrounding inflatable rubber sheath. These can be installed in various positions and spacings by lowering uninflated and then inflating with gas or liquid to substantial pressures (e.g. 5.5 MPa) to seal against the sides of the borehole. This technique is regularly used in hydrocarbon exploration boreholes.

Referring to FIG. 41 the DIZOIGS comprises a large reel 200, two inflatable packers 202 and 204, a pressure transducer and pumping equipment located in a housing 206 above the top packer 202, a PGNA data logger and associated control equipment located in a housing 208 in the ZOI, and associated sampling/injection lines and equipment 210, for example sample and pumping tubes, air lines, wire support rope, data cable and pump supply line. Taking samples in the borehole 212 at depth under hydrostatic pressures minimises dissolved gas losses that typically occur during pumping of a water sample to the surface. Also located within the ZOI are sample port 209 and pumping port 211.

### Operation of DIZOIGS

1. After determining the zone of interest (ZOI) through conventional borehole information (e.g. stratigraphic, caliper, sonic, camera or other logging), the spacing between the inflatable packers 202 and 204 is fixed by installing an appropriate length of support cable and inflation line between the two packers.

2. The 7.5 L in-line sample chamber and sampling line 214, with normally closed valves and sampling ports top and bottom, are pre-purged with nitrogen by operating the normally-closed pneumatic sample chamber valves and turning on the nitrogen-purge tap. The valves and taps are then closed off.

3. The assembly is lowered to the requisite depth using the attached depth measure, which indicates the zero position as the top of the ZOI (i.e. the lower end of the inflatable portion of the top packer 202).

4. Once the down-hole assembly is in position, the pumping line is primed by operating the pump in housing 206 prior to inflation of the packers 202 and 204, then closing off the pump line tap at the reel 200. (This allows some purging of the pump line and easy monitoring of pumped quantities after inflation).

5. The packers 202 and 204 are inflated with nitrogen or water from a tank 216 to approximately 2-3 MPa above background pressure (depending on the borehole conditions), which is indicated by the inbuilt pressure transducer located in housing 206 or can be calculated by depth below the standing water level. Adequate inflation against a clean portion of the borehole walls isolates the zone of interest from the rest of the borehole. The ZOI is now ready for sampling and/or injection.

6. Prior to collecting a sample, the isolated ZOI is repeatedly pumped and allowed to recover formation pressure to purge any remaining mixed waters and/or contaminants from the drilling process. This is continued until measured parameters or extracted volumes indicate that representative formation water is filling the entire ZOI,

7. The sample chamber is opened by operating the normally-closed sample chamber valves, allowing water to rise and displace the nitrogen gas used for purging the line and chamber. The pressure transducer and gas outflow from the top of the sample line is monitored to ascertain when the water level within the sample line has filled or approached equilibrium. Once flow has stopped the sample chamber valves are closed off. The packers can now be deflated and the sample brought to the surface for collection via sampling ports. If necessary the sample can be purged from the sample chamber using nitrogen at a pressure suited to the sample collection assembly.

8. For injection, steps 1-5 are followed first. The injection fluid can then be inserted into the ZOI via the sampling line, with normally-closed valves in the open position. If circulation is required for mixing of the injection fluid, the pump is also operated simultaneously to return the water from ZOI to the surface tanks of injection fluid (i.e. as per the system depicted in FIG. 27). The rate of injection or mixing is controlled by the inflow and outflow rates.

9. Following injection, sufficient time is allowed for penetration of the injection solution into the porous strata and fractures.

10. Packers are deflated and the assembly removed from the hole in preparation for logging.

Modifications and variations such as would be apparent to a skilled addressee are deemed to be within the scope of the present invention. It is to be understood that the present invention should not be restricted to the particular embodiments described above.

1.-91. (canceled)

92. A method of determining the distance, from a borehole, of a tracer in an underground environment, the tracer emitting gamma radiation comprising a first component emitted at a first known energy level and a second component emitted at a second known energy level, the intensity of a penetrating portion of the first component that penetrates the environment and the intensity of a penetrating portion of the second component that penetrates the environment being a function of the rate of gamma radiation emission of the tracer and the distance of the tracer from the borehole, the method comprising the steps of:
a) measuring the intensity of the first penetrating portion and the intensity of the second penetrating portion using a gamma radiation scintillation detector;
b) determining the ratio of the intensity of the first penetrating portion to the intensity of the second penetrating portion; and
c) determining the distance of the tracer from the borehole by differential gamma radiation attenuation as it is displaced by the injection of water into the borehole.

93. A method as claimed in claim 92 wherein step (c) comprises determining the distance of the tracer from the borehole using the equation
$$\begin{matrix}Rt ( l ) ≡ \frac{{I}_{tot}^{1} ( l )}{{I}_{tot}^{2} ( l )} \\ = \frac{{μ}_{2}}{{μ}_{1}} \frac{1 - {e}^{- {μ}_{1} l}}{1 - {e}^{- {μ }_{2} l}} ,\end{matrix}$$
wherein:
Rt(l) is the ratio of the integral intensities of the tracer gamma radiation emission at two different energies;
l is the distance of the volume of a liquid containing the tracer from the borehole;
Iₜₒₜ¹(l) represents the total (integral) intensity of the tracer at the first energy as a function of the distance from the borehole;
Iₜₒₜ²(l) represents the total (integral) intensity of the tracer at the second energy as a function of the distance from the borehole;
μ₁ is the attenuation coefficient of the first component of the radiation corresponding to the first the energy; and
μ₂ is the attenuation coefficient of the second component of the radiation corresponding to the second the energy; and further wherein if an activatable tracer is used then the method further comprises the step of activating the activatable tracer before the step of measuring the intensity of the first penetrating portion and the intensity of the second penetrating portion.

94. A method as claimed in claim 92 further comprising the steps of
d) mixing the tracer with water throughout a column of water or other liquid in a borehole located at the borehole; and
e) applying a known pressure head to the borehole to induce the injection of the tracer into the environment of the borehole wherein the pressure head in the borehole is maintained constant at a constant pressure to ensure that the tracer is injected into the borehole environment at a constant rate with a known injection time and known tracer injection volume.

95. A method as claimed in claim 92 wherein the tracer is a tracer solution selected from the group of:
a radioactive tracer solution selected from the group of: ⁸²Br, a salt comprising a radioactive isotope, or a salt labelled with ⁸²Br; or
a radioactive tracer solution selected from the group of sodium bromide wherein the bromide is ⁸²Br, or potassium bromide wherein the bromide is ⁸²Br; or
an activatable tracer solution selected from the group of: a chemically conservative salt solution, a chemically conservative salt solution selected from the group of NaCl, KCl, MnCl₂, Na₂SO₄, K₂SO₄, NH₄Cl, NaBr or KBr; or a mixture of two or more chemically conservative salts.

96. A method as claimed in claim 92 wherein the source is a neutron radiation source, the radiation being capable of causing elements in the borehole environment to become radioactive, wherein the neutrons have a penetrating range of approximately 1 mm to 1 m.

97. A method as claimed in claim 96 wherein the tracer is an activatable tracer wherein one or more of the elements in the salt are able to be activated with incident neutrons to emit gamma radiation and step (a) comprises the steps of:
a1) activating the activatable tracer; and
a2) measuring the intensity of the penetrating portion of the first and second energy components of the activatable tracer.

98. A method as claimed in claim 97 wherein the tracer is an activatable salt and the distance of the tracer from the borehole is measured by diminution of the intensity of the activatable salt as it is displaced by the injection of water into the borehole.

99. A method as claimed in claim 98 wherein the tracer is sodium chloride present in underground water.

100. A method as claimed in claim 98 wherein the distance of the tracer from the borehole is determined by differential gamma radiation attenuation as it is displaced by the injection of water into the borehole.

101. A method as claimed in claim 92 further comprising the step of shielding the detector from radiation originating from all directions except a desired measurement direction to determine the distance of the tracer from the borehole in the desired measurement direction.

102. A method as claimed in claim 92 wherein the measured gamma energy level of the radiation is in the range of approximately 0.1 MeV to 10 MeV.

103. A method as claimed in claim 92 wherein the difference between the first and second gamma energy levels is greater than 0.1 MeV.

104. A method as claimed in claim 92 wherein an activatable tracer is introduced into the underground environment forming a tracer plume in the environment and wherein
step (a) comprises the steps of:
a1) activating the activatable tracer; and
a2) after the elapse of a period of time, measuring the intensity of the first penetrating portion and the second penetrating portion;
step (c) comprises determining a distance that the tracer has moved in the environment, away from a reference point comprising the location of the borehole, during the period of time, by differential gamma radiation attenuation as it is displaced by the injection of water into the borehole; and
wherein the method further comprises the step of:
d) determining the volume of the tracer plume. wherein the volume of the plume is determined from the equation V=πr²H+επ(R²−r²)H wherein
V is the volume of the plume in borehole and porous rock;
R is the radius of the plume formed when the solute occupied the given volume during the said period of time. The equation similar to one-dimensional equation (1) but generalised for the axi-symmetrical case can be used for determining the radial distance R;
r is the radius of the borehole;
H is the height of the cylindrical plume; and
ε is the porosity of the rock volume within the radius R (0≦ε≦1).

105. A method of determining a hydraulic conductivity of an underground environment in the direct vicinity of a borehole, the method comprising the steps of:
a) introducing into the environment, from the borehole, and at a known depth, a radioactive or activatable tracer emitting radiation comprising the first and second components emitted at two known energy levels penetrating the environment;
b) after the elapse of a period of time, t₁, measuring the intensity of the first and second penetrating energy components of the tracer, at least at the known depth, using a detector located in the borehole;
c) determining the ratio of the measured intensity of the first penetrating energy component to the measured intensity of the second penetrating energy component;
d) using the penetrating energy ratio, determining a distance, R₁, that the tracer has moved in the environment, away from the borehole, during the time period;
e) determining the seepage velocity of the liquid moving in the environment and containing the tracer, under a measured hydraulic gradient, wherein the hydraulic gradient is determined by the difference between hydraulic pressure in the borehole and the hydraulic pressure in the adjacent rock; and
f) determining the hydraulic conductivity in the vicinity of the borehole using Darcy's law.

106. A method as claimed in claim 105 wherein the tracer is an activatable tracer and step (b) comprises the steps of:
b1) activating the activatable tracer; and
b2) measuring the intensity of the first penetrating portion and the second penetrating portion.

107. A method as claimed in claim 105 wherein the seepage velocity Vₛₚ is determined by dividing the determined distance R over elapsed time t, that is Vₛₚ=R/t.

108. A method as claimed in claim 105 wherein, prior to step (e), the method comprises the step:
(d1) repeating steps (a) to (d) and determining a distance R₂ that the tracer has moved further in the environment, away from the borehole, during a new time period, t₂, from the repeated step (b); and
wherein the seepage velocity is determined by dividing the determined distance difference R₂−R₁ over elapsed time difference t₂−t₁, that is Vₛₚ=(R₂−R₁)/(t₂−t₁).

109. A method as claimed in claim 105 wherein the hydraulic conductivity is determined by the equation
$$\begin{matrix}K = {V}_{sp} \frac{Δ r}{Δ Ψ} \\ \approx \frac{Δ r}{Δ t} \times \frac{Δ r}{Δ Ψ} \\ = \frac{{( Δ r )}^{2}}{Δ ΨΔ t} ,\end{matrix}$$
wherein:
K is the hydraulic conductivity (measured in m/s) of the environment of the borehole,
Vₛₚ is Darcy's seepage velocity,
t is the time period;
r is the distance; and
Ψ=ψ+p/ρg is the total pressure head in meters with ψ being liquid head, p—atmospheric pressure, ρ—liquid density, g—acceleration due to gravity.

110. A method as claimed claim 108 wherein the hydraulic conductivity of the underground environment is determined in respect of a plane incorporating the axis of the borehole and extending in a first direction, by measuring the intensities of the penetrating portions of the first component and the second component of radiation, at the known depths and at given directions.

111. A method as claimed in claim 108 wherein the hydraulic conductivity of the underground environment is determined for a cylindrical space incorporating the borehole and being co-axial with the borehole, by measuring the intensities of penetrating portions of the first component and the second component of radiation by determining the volume occupied by the liquid from the borehole, before the elapse of the time period and thereafter.

112. An apparatus for determining the distance from a borehole of a volume of liquid in an underground environment of the borehole, the volume of liquid comprising a tracer emitting gamma radiation, the radiation comprising a first component radiated at a first known energy level and a second component radiated at a second known energy level, the intensity of a penetrating portion of each of the first and second components of the radiation being a function of the source intensity of the tracer as well as of the distance of the tracer from the borehole; the apparatus comprising:
a PGNA borehole logging device comprising: a gamma radiation scintillation detector for measuring the intensities of the penetrating portions of the first component and the second component, at least at the known depth and at least in respect of a first direction;
means for determining the ratio of the intensity of the first penetrating portion to the intensity of the second penetrating portion;
means for injecting the liquid into the borehole; means for measuring and monitoring the concentration of the tracer in the liquid;
means for monitoring and adjusting the flow rate of the liquid to the borehole;
means for measuring and monitoring the volume of the liquid;
means for measuring the hydraulic pressure in the borehole; and
means for determining the distance of the volume of liquid from the borehole.

113. An apparatus as claimed in claim 112 further comprising means for measuring the hydraulic gradient, being the difference between hydraulic pressure in the borehole and the hydraulic pressure in the adjacent rock, and determining the hydraulic conductivity of the liquid in the underground environment in the vicinity of the borehole from the distance of the tracer from the borehole and the hydraulic gradient.

114. An apparatus as claimed in claim 112 wherein the tracer is selected from the group of a radioactive tracer or an activatable tracer and wherein, where the tracer is an activatable tracer, the PGNA borehole logging tool further comprises a neutron emission source adapted for activating the activatable tracer.

115. An apparatus as claimed in claim 112 wherein the detector is shielded in respect of radiation originating from all directions except a desired measurement direction to measure the intensities of the penetrating portions of the first component and the second component in the desired measurement direction.

116. An apparatus as claimed in claim 112 wherein the desired measurement direction from which radiation is measured may be varied or progressively increased for sequential measurements.
